(19) United States
(12) Patent Application Publication
(10) Pub. No.: US 2020/0165163 A1
(43) Pub. Date: May 28, 2020

(54) TRANSPARENT HEAT-SHIELDING/HEAT-INSULATING MEMBER, AND METHOD FOR MANUFACTURING SAME

(71) Applicant: MAXELL HOLDINGS, LTD., Otokuni-gun, Kyoto (JP)

(72) Inventors: Takuo MIZUTANI, Otokuni-gun, Kyoto (JP); Teruhisa MIYATA, Otokuni-gun, Kyoto (JP); Fumie MITSUHASHI, Otokuni-gun, Kyoto (JP)

(73) Assignee: MAXELL HOLDINGS, LTD., Otokuni-gun, Kyoto (JP)

(21) Appl. No.: 16/627,182

(22) PCT Filed: Jun. 26, 2018
(86) PCT No.: PCT/JP2018/024174

§ 371 Date: Dec. 27, 2019

(30) Foreign Application Priority Data
Jun. 28, 2017 (JP) 2017-126578
Aug. 29, 2017 (JP) 2017-164614

(51) Int. Cl. C03C 17/42; C03C 17/38; E06B 9/24; C03C 17/36; F28F 13/18

(52) U.S. Cl. CPC C03C 17/42; C03C 17/38; E06B 9/24; C03C 17/3644; F28F 2245/06; C03C 17/366; C03C 2217/78; E06B 2009/2417; F28F 2270/00; F28F 13/18

(57) ABSTRACT

A transparent heat-shielding/heat-insulating member including a transparent base substrate and a functional layer formed on the transparent base substrate. The functional layer includes an infrared reflective layer and a protective layer in this order from the transparent base substrate side. The infrared reflective layer includes a first metal suboxide layer or metal oxide layer, a metal layer, and a second metal suboxide layer or metal oxide layer in this order from the transparent base substrate side. The total thickness of the infrared reflective layer is ≤25 nm. The thickness of the second metal suboxide layer or metal oxide layer is ≤25% of the total thickness of the infrared reflective layer. The protective layer contains a single layer or multiple layers. At least the layer of the protective layer that is in contact with the second metal suboxide layer or metal oxide layer includes a corrosion inhibitor for metal.

### TECHNICAL FIELD

The present invention mainly relates to a transparent heat-shielding/heat-insulating member such as a year-round energy-saving solar radiation control film that is used by applying it to the indoor side of window glass or the like. In particular, the present invention relates to a transparent heat-shielding/heat-insulating member such as a year-round energy-saving solar radiation control film that has excellent heat insulation properties, a low solar absorptance, and resistance to corrosion and degradation caused by, e.g., water condensation and adhesion of human sebum, and a method for producing the transparent heat-shielding/heat-insulating member.

### BACKGROUND ART

From the viewpoint of preventing global warming and improving energy conservation, heat shielding films have been widely used to block heat rays (infrared rays) of sunlight and reduce the indoor temperature. The heat shielding films are applied to, e.g., building windows, show windows, and automobile windows. In recent years, to achieve further energy conservation, there have been demands for films having not only the heat shielding properties capable of blocking the heat rays that cause a rise in temperature in summer, but also a heat insulation function that prevents heat loss from the room and reduces heating loads in winter. Accordingly, year-round energy-saving heat-shielding/heat-insulating members have been developed and become better known as they are put on the market.

In view of the fact that films with excellent heat insulation properties have been increasingly commercialized, while various solar radiation control films are coming on the market, the standards on films for building window glass defined by the Japanese Industrial. Standard (JIS) A5759 were revised in 2016, and a new category regarding the use and performance of “low emissivity films” was added to further clarify the definition of heat insulation.

In JIS A5759-2016, the low emissivity films are classified into the following four types A to D according to the combination of a visible light transmittance and a thermal transmittance that is an indicator of heat insulation performance.

Type A: visible light transmittance of less than 60%, thermal transmittance of 4.2 W/(m²·K) or less

Type B: visible light transmittance of less than 60%, thermal transmittance of more than 4.2 W/(m²·K) and 4.8 W/(m²·K) or less

Type C: visible light transmittance of 60% or more, thermal transmittance of 4.2 W/(m²·K) or less

Type D: visible light transmittance of 60% or more, thermal transmittance of more than 4.2 W/(m²·K) and 4.8 W/(m²·K) or less

Out of the above low emissivity films divided into the four types, the low emissivity films of Type A and Type C, in which the thermal transmittance is 4.2 W/(m²·K) or less, particularly have high heat insulation properties. Thus, the low emissivity films of these types are expected to penetrate the market gradually in the future.

Recently, in order to further improve the heat insulation and also to further increase the energy-saving effect in winter, one of the development targets for next-generation low emissivity films is to provide products that are classified in Type A and Type C, but have a thermal transmittance of 4.0 W/(m²·K) or less, specifically 3.6 to 3.8 W/(m²·K).

The configuration of a low emissivity film may be generally the same as that of an infrared reflective film, in which a metal oxide layer, a metal layer, a metal oxide layer, and a transparent protective layer (hard coat layer) are formed in this order on a transparent base substrate. The laminated portion of the metal oxide layer, the metal layer, and the metal oxide layer constitutes an infrared reflective layer with relatively high transparency. The metal oxide layers have the functions of: adjusting a visible light reflectance by the interference effect at their respective interfaces with the metal layer that reflects infrared rays; controlling the balance between the visible light transmittance and the infrared reflectance of the entire infrared reflective layer; and suppressing the corrosion and degradation of the metal layer. However, the infrared reflective layer with this configuration is insufficient in scratch resistance. Moreover, the metal layer is protected by only the metal oxide layers, and therefore can be easily corroded and degraded in the environment that be significantly affected by the synergistic action of external factors such as oxygen, water, and chloride ions. Thus, a transparent protective layer is further provided on the infrared reflective layer to improve the scratch resistance of the infrared reflective layer and reduce the influence of the external factors.

However, when the thermal transmittance of the low emissivity film is reduced to 4.2 W/(m²·K) or less, and further to 4.0 W/(m²·K) or less in order to improve the heat insulation further, it is necessary to reflect far infrared rays more efficiently on the indoor side (i.e., to make a normal emissivity smaller). Thus, the transparent protective layer should be thin as much as possible. The reason for this is as follows. To improve the scratch resistance of the protective layer, the protective layer has to be made of, e.g., materials that easily absorb far infrared rays (in which many C═O groups, C—O groups, and aromatic groups are contained in the molecular skeleton) such as a radiation curable acrylic hard coating material. Therefore, the larger the thickness of the protective layer is, the more it absorbs far infrared rays. Consequently the solar radiation control film itself absorbs far infrared rays, and cannot efficiently reflect the far infrared rays on the indoor side.

While it is difficult to make sweeping statements about the thickness of the protective layer because it may depend on the materials of the protective layer, in a specific example, assuming that the infrared reflective layer sewing as a base has a thermal transmittance of 3.7 W/(m²·K), the thickness of the protective layer should be about 1.0 μm or less, e.g., so as to reduce the thermal transmittance of the low emissivity film to 4.2 W/(m²·K) or less. Similarly, the thickness of the protective layer should be about 0.7 μm or less, e.g., so as to reduce the thermal transmittance of the low emissivity film to 4.0 W/(m²·K) or less. Further, the thickness of the protective layer should be about 0.5 μm or less, e.g., so as to reduce the thermal transmittance of the low emissivity film to 3.8 W/(m²·K) or less.

As the conventional technologies, Patent Document 1 is intended to provide an infrared reflective film with both excellent heat insulation properties and practical durability. Patent Document 1 discloses an infrared reflective film in which a first metal oxide layer, a metal layer composed mainly of silver, and a second metal oxide layer that is a composite metal oxide layer including zinc oxide and tin oxide are provided on a transparent base substrate. A transparent protective layer is in direct contact with the second metal oxide layer. The thickness of the protective layer is 30 nm to 150 nm. The protective layer has a crosslinked structure derived from an ester compound having an acidic group and a polymerizable functional group in the same molecule.

Patent Document 2 is intended to provide an infrared reflective film that has excellent heat shielding properties and can effectively prevent a reflection of the resident's face or the like in the window to which the infrared reflective film is applied. Patent Document 2 discloses an infrared reflective film in which a first metal oxide layer, an infrared reflective layer, a second metal oxide layer, and a transparent protective layer are formed in this order on a transparent base substrate. The thickness of the second metal oxide layer is 30 nm or less. The thickness of the first metal oxide layer is smaller than that of the second metal oxide layer. A difference in thickness between the first metal oxide layer and the second metal oxide layer is 2 nm or more.

Similarly, Patent Document 3 is intended to provide a transparent heat-shielding/heat-insulating member with both excellent heat insulation properties and appearance. Patent Document 3 discloses a transparent heat-shielding/heat-insulating member in which an infrared reflective layer and a protective layer are provided in this order on a transparent base substrate. The infrared reflective layer includes at least a metal layer and a metal suboxide layer composed of partially oxidized metal. The total thickness of the protective layer is 200 to 980 nm. The protective layer includes at least a high refractive index layer and a low refractive index layer in this order from the infrared reflective layer side.

### PRIOR ART DOCUMENTS

### Patent Documents

Patent Document 1: JP 2014-167617A
Patent Document 2: JP 2017-68118A
Patent Document 3: JP 2017-053967A

### DISCLOSURE OF INVENTION

### Problem to be Solved by the Invention

As described in the above patent documents, the thermal transmittance of the low emissivity film can be further reduced as the transparent protective layer becomes thinner. On the other hand, a further decrease in the thickness of the transparent protective layer generally reduces the function of protecting the infrared reflective layer from external environmental factors such as oxygen, water, and chloride ions. This means that the time it takes for oxygen, water, and chloride ions to penetrate and diffuse in the depth direction of the protective layer will be shortened, so that the metal layer is more susceptible to corrosion and degradation.

To solve the problem of corrosion and degradation of the metal layer, Patent Document 1 teaches that a composite metal oxide (ZTO) containing zinc oxide and tin oxide with excellent chemical stability (i.e., resistance to acids, alkalis, chloride ions, etc.) is used for the metal oxide layer of the infrared reflective layer that is located in contact with the transparent protective layer.

However, since both the first metal oxide layer and the second metal oxide layer (ZTO layer) have a large thickness of about 30 nm, the infrared reflective film of Patent Document 1 is considered to have a relatively high visible light transmittance, a relatively low visible light reflectance, and a relatively high solar absorptance (about 25% to 30%). When the infrared reflective film is applied to window glass, the temperature rises near the center of the widow glass depending on, e.g., the type, direction, and shadow of the window glass. Thus, there is a possibility that the window glass will be thermally cracked. Moreover, due to a relatively large thickness of the ZTO layer, the infrared reflective film of Patent Document 1 still has room for improvement, e.g., in terms of cost and manufacturing efficiency in the sputtering film formation. On the other hand, if the thickness of the first metal oxide layer and/or the second metal oxide layer of the infrared reflective film is reduced in order to reduce the solar absorptance of the infrared reflective film, the function of protecting the metal layer is reduced, and the metal layer will be easily corroded, which may lead to a reduction in heat shielding and heat insulation functions and poor appearance.

To solve the problem of corrosion and degradation of the metal layer, similarly to Patent Document 1, Patent Document 2 also teaches that a composite metal oxide (ZTO) containing zinc oxide and tin oxide with excellent chemical stability (i.e., resistance to acids, alkalis, chloride ions, etc.) is used for the metal oxide layer of the infrared reflective layer that is located in contact with the transparent protective layer.

However, the first metal oxide layer has a thickness of 4 to 15 nm and the second metal oxide layer has a thickness of 10 to 25 nm. Since these metal oxide layers are still thick, the infrared reflective film of Patent Document 2 also has a high solar absorptance of 22 to 35%. When the infrared reflective film is applied to window glass, the temperature rises near the center of the widow glass depending on, e.g., the type, direction, and shadow of the window glass, Thus, there is a possibility that the window glass will be thermally cracked. On the other hand, if the thickness of the first metal oxide layer and/or the second metal oxide layer of the infrared reflective film is reduced in order to reduce the solar absorptance of the infrared reflective film, the function of protecting the metal layer is reduced, and the metal layer will be easily corroded, which may lead to a reduction in heat shielding and heat insulation functions and poor appearance.

Patent Document 3 tries to solve the problem of corrosion and degradation of the metal layer by providing the metal suboxide layer composed of partially oxidized metal on the metal layer, and performs a corrosion resistance test in which the transparent heat-shielding/heat-insulating member is allowed to stand at a temperature of 50° C. and a relative humidity of 90% for 168 hours. Since the metal suboxide layer (TiOₓ layer) has a small thickness of 2 to 6 nm, the transparent heat-shielding/heat-insulating member of Patent Document 3 is considered to have a relatively high visible light reflectance and a relatively low solar absorptance. Therefore, when the transparent heat-shielding/heat-insulating member is applied to window glass, the risk of thermal cracking of the window glass may be reduced. Moreover, due to a small thickness of the TiOₓ layer, the transparent heat-shielding/heat-insulating member of Patent Document 3 has been improved, e.g., in terms of cost and manufacturing efficiency in the sputtering film formation.

However, in the transparent heat-shielding/heat-insulating member of Patent Document 3, the thickness of the TiOₓ layer used as the metal suboxide layer is as small as 2 to 6 nm, and the thickness of the protective layer formed on the TiOₓ layer is also as small as 210 to 930 nm. Making these layers thin may not be a problem in the corrosion resistance test in which the transparent heat-shielding/heat-insulating member is allowed to stand at a temperature of 50° C. and a relative humidity of 90% for 168 hours. However, when the transparent heat-shielding/heat-insulating member is used in a harsh environment, particularly, where condensation is extremely likely to occur on the surface of the transparent heat-shielding/heat-insulating member while people touch the surface with their hands or fingers so that chlorides or the like contained in human sebum adhere to it, the corrosion and degradation of the metal layer can be accelerated due to the synergistic action of external environmental factors such as oxygen, water, and chloride ions, as described above. This may lead to a reduction in heat shielding and heat insulation functions and poor appearance.

Under the current circumstances, when the thermal transmittance of the low emissivity film is reduced to 4.2 W/(m²·K) or less, and further to 4.0 W/(m²·K) or less in order to improve the heat insulation further, the low emissivity film cannot meet the following requirements: (i) the film should have a low solar absorptance to reduce the risk of thermal cracking of window glass to which it is applied; and (ii) the film should have excellent resistance to corrosion and degradation when it is used in the harsh environment that will be affected by the synergistic action of external environmental factors such as oxygen, water, and chloride ions.

The present invention solves the problem that the heat-shielding/heat-insulating member cannot meet two conflicting requirements for reducing the solar absorptance and suppressing corrosion and degradation in the harsh operating environment. In particular, the present invention provides a transparent heat-shielding/heat-insulating member such as a year-round energy-saving solar radiation control film that has excellent heat insulation properties, a low solar absorptance, and resistance to corrosion and degradation caused by e.g., water condensation and adhesion of human sebum.

### Means for Solving Problem

To solve the above problem, first, the present inventors performed a salt water resistance test particularly on the heat-shielding/heat-insulating member of Patent Document 3. The salt water resistance test assumed a harsh operating environment.

The heat-shielding/heat-insulating member was immersed in a sodium chloride aqueous solution with a concentration of 5% by mass at 50° C. for 10 days. Then, the transmission spectrum in the wavelength range of 300 to 1500 nm was measured before and after the immersion. The results confirmed that the transmission spectrum was changed after the immersion, and the near infrared reflection function tended to be reduced. In this case, the far infrared reflection function with a wavelength of 5.5 μm to 25.2 μm was also reduced. Moreover, the heat-shielding/heat-insulating member was taken out during the test, and its surface was observed. Consequently, it was found that the corroded and degraded portions were present mainly in the form of dots in the initial state of corrosion and degradation. This heat-shielding/heat-insulating member had a configuration in which the metal suboxide layer and the protective layer (though both were thin) were formed on the metal layer. Nevertheless, the resistance of the metal layer to corrosion and degradation in the harsh operating environment was lower than expected. Under these circumstances, the present inventors intensively studied and estimated the causes of corrosion and degradation as follows.

In the above heat-shielding/heat-insulating member, as the infrared reflective layer, the first metal suboxide layer, the metal layer, and the second metal suboxide layer were formed in this order on the transparent base substrate by sputtering. In this case, the metal suboxide layers were extremely thin, such as several nanometers, in order to relatively increase the visible light reflectance and to reduce the solar absorptance. This may have affected the corrosion and degradation of the metal layer. The SEM/EDX analysis of the surface of the infrared reflective layer revealed that the following (1) and (2) were present on small protrusions of the transparent base substrate (e.g., spike filler in the base substrate, lubricant filler in the easy adhesion layer, and foreign matter): (1) a very small site where the metal layer is not completely covered with the second metal suboxide layer, and (2) a very small site where the infrared reflective layer itself is partially torn and coming off (i.e., the metal layer is exposed at the end face of the torn layer). Moreover, surprisingly the following (3) was also present, though the reason was not clear: (3) a very small aggregate or bump of metal derived from the metal layer, which seems to have stuck through the second metal suboxide layer.

In any case, the present inventors found out that “very small metal sites where the metal layer is not completely covered with the second metal suboxide layer, and metal derived from the metal layer is exposed. (including a very small aggregate or bump of metal),” as described in (1) to (3) above, were present on the surface of the infrared reflective layer. Thus, the present inventors considered that these metal sites would be a major cause of the corrosion and degradation of the metal layer of the heat-shielding/heat-insulating member when it was used in the harsh environment, as described above. In other words, the present inventors made the following assumption. Although the protective layer containing an organic substance and an inorganic oxide was formed on the infrared reflective layer, the thickness of the protective layer was as small as 210 to 930 μm, making it difficult to fully prevent the diffusion and penetration of oxygen, water, and chloride ions. Therefore, when the heat-shielding/heat-insulating member was used in the harsh environment, oxygen, water, and chloride ions gradually penetrated and diffused into fine gaps in the protective layer, and once they reached the “very small metal sites where the metal layer is not completely covered with the second metal suboxide layer, and metal derived from the metal layer is exposed,” the corrosion and degradation of metal started from these very small metal sites and progressed, while spreading gradually throughout the entire metal layer.

As a result of the intensive studies to solve the above problem, the present inventors found that when a transparent heat-shielding/heat-insulating member had a configuration in which a first metal suboxide layer or metal oxide layer, a metal layer, and a second metal suboxide layer or metal oxide layer were formed in this order on a transparent base substrate to constitute an infrared reflective layer, and a protective layer composed of a single layer or multiple layers was further provided on the infrared reflective layer, the transparent heat-shielding/heat-insulating member was advantageous in the following ways. First, if a corrosion inhibitor for metal was included in the layer of the protective layer that was in contact with the second metal suboxide layer or metal oxide layer, the corrosion inhibitor for metal was adsorbed on the “very small metal sites where the metal layer is not completely covered with the second metal suboxide layer or metal oxide layer, and metal derived from the metal layer is exposed,” as described in (1) to (3) above, so that a corrosion protection layer, i.e., a barrier layer was formed. The corrosion protection layer was able to protect the very small metal sites from external environmental factors such as oxygen, water, and chloride ions. Consequently the progress of corrosion and degradation of the metal layer was significantly suppressed, Second, if the layer of the protective layer that was located on the outermost side included a fluorine-containing (methacrylate, a silicone-modified acrylate, and an ionizing radiation curable resin copolymerizable with the fluorine-containing (meth)acrylate and the silicone-modified acrylate, not only the anti-stick properties and ease of wiping of the surface of the protective layer against human sebum, but also water repellency could be improved. This reduced the influence of the external environmental factors such as water and chloride ions on the very small metal sites, i.e., reduced the penetration of water and chloride ions into the protective layer. Consequently the progress of corrosion and degradation of the metal layer was further suppressed. Based on these findings, the present inventors have reached the present invention.

The transparent heat-shielding/heat-insulating member of the present invention includes a transparent base substrate and a functional layer formed on the transparent base substrate. The functional layer includes an infrared reflective layer and a protective layer in this order from the transparent base substrate side. The infrared reflective layer includes a first metal suboxide layer or metal oxide layer, a metal layer, and a second metal suboxide layer or metal oxide layer in this order from the transparent base substrate side. The total thickness of the infrared reflective layer is 25 nm or less. The thickness of the second metal suboxide layer or metal oxide layer is 25% or less of the total thickness of the infrared reflective layer. The protective layer is composed of a single layer or multiple layers. At least the layer of the protective layer that is in contact with the second metal suboxide layer or metal oxide layer includes a corrosion inhibitor for metal. More preferably, the layer of the protective layer that is located on the outermost side includes a fluorine atom and a siloxane bond.

In this aspect, it is preferable that the corrosion inhibitor for metal contains at least one compound selected from a compound having a nitrogen-containing group and a compound having a sulfur-containing group.

It is preferable that the content of the corrosion inhibitor for metal is 1% by mass or more and 20% by mass or less of the total mass of a layer including the corrosion inhibitor for metal.

It is preferable that the resin containing a fluorine atom and a siloxane bond is a copolymer resin that contains a fluorine-containing (meth)acrylate, a silicone-modified acrylate, and an ionizing radiation curable resin as resin components before polymerization, and that the ionizing radiation curable resin is copolymerizable with the fluorine-containing (meth)acrylate and the silicone-modified acrylate.

It is preferable that the content of the fluorine-containing (meth)acrylate is 4% by mass or more and 20% by mass or less of the total mass of the resin components before polymerization, and that the content of the silicone-modified acrylate is 1% by mass or more and 5% by mass or less of the total mass of the resin components before polymerization.

It is preferable that the total thickness of the infrared reflective layer is 7 nm or more.

It is preferable that the protective layer includes a high refractive index layer and a low refractive index layer in this order from the infrared reflective layer side.

It is more preferable that the protective layer includes a medium refractive index layer, a high refractive index layer, and a low refractive index layer in this order from the infrared reflective layer side.

It is most preferable that the protective layer includes an optical adjustment layer, a medium refractive index layer, a high refractive index layer, and a low refractive index layer in this order from the infrared reflective layer side.

It is preferable that the total thickness of the protective layer is 200 to 980 nm.

It is preferable that a metal suboxide or a metal oxide included in the second metal suboxide layer or metal oxide layer of the infrared reflective layer contains a titanium component.

It is preferable that the metal layer of the infrared reflective layer includes silver, and that the thickness of the metal layer is 5 to 20 nm.

It is preferable that the transparent heat-shielding/heat-insulating member has a visible light transmittance of 60% or more, a shading coefficient of 0.69 or less, a thermal transmittance of 4.0 W/(m²·K) or less, and a solar absorptance of 20% or less.

It is preferable that a salt water resistance test is performed by immersing the transparent heat-shielding/heat-insulating member in a sodium chloride aqueous solution with a concentration of 5% by mass at 50° C. for 10 days, and that a value of T_{A}-T_{B} is less than 10 points, where T_{B}% represents a transmittance of the transparent heat-shielding/heat-insulating member for light with a wavelength of 1100 ran of a transmission spectrum in a wavelength range of 300 to 1500 nm measured before the salt water resistance test, and T_{A}% represents a transmittance of the transparent heat-shielding/heat-insulating member for light with a wavelength of 1100 nm of the transmission spectrum in the wavelength range of 300 to 1500 nm measured after the salt water resistance test.

A method for producing the transparent heat-shielding/heat-insulating member of the present invention includes forming an infrared reflective layer on a transparent base substrate by a dry coating method, and forming a protective layer on the infrared reflective layer by a wet coating method.

### Effects of the Invention

The present invention can provide a transparent heat-shielding/heat-insulating member that has a high visible light transmittance, excellent heat shielding properties and heat insulation properties, a low solar absorptance, and resistance to corrosion and degradation caused by, e.g., water condensation and adhesion of human sebum. The transparent heat-shielding/heat-insulating member of the present invention can reduce the risk of thermal cracking of window glass to which it is applied, and can also maintain the heat shielding and heat insulation functions and good appearance over a long period of time.

### BRIEF DESCRIPTION OF DRAWING

FIG. 1 is a schematic cross-sectional view showing an example of a transparent heat-shielding/heat-insulating member of an embodiment.

FIG. 2 is a diagram showing an example of a transmission spectrum of a transparent heat-shielding/heat-insulating member before and after a salt water resistance test.

### DESCRIPTION OF THE INVENTION

(Transparent Heat-Shielding/Heat-Insulating Member)

First, an embodiment of a transparent heat-shielding/heat-insulating member of the present invention is described. The embodiment of the transparent heat-shielding/heat-insulating member of the present invention includes a transparent base substrate and a functional layer formed on the transparent base substrate. The functional layer includes an infrared reflective layer and a protective layer in this order from the transparent base substrate side. The infrared reflective layer includes a first metal suboxide layer or metal oxide layer, a metal layer, and a second metal suboxide layer or metal oxide layer in this order from the transparent base substrate side. The total thickness of the infrared reflective layer is 25 nm or less. The thickness of the second metal suboxide layer or metal oxide layer is 25% or less of the total thickness of the infrared reflective layer. The protective layer is composed of a single layer or multiple layers. At least the layer of the protective layer that is in contact with the second metal suboxide layer or metal oxide layer includes a corrosion inhibitor for metal. More preferably, the layer of the protective layer that is located on the outermost side includes a resin containing a fluorine atom and a siloxane bond.

In the above configuration, the corrosion inhibitor for metal is included in at least the layer of the protective layer (composed of a single layer or multiple layers) that is in contact with the second metal suboxide layer or metal oxide layer of the infrared reflective layer. Therefore, even if the second metal suboxide layer or metal oxide layer is made thin to reduce the solar absorptance, the corrosion inhibitor for metal is adsorbed on the “very small metal sites where the metal layer is not completely covered with the second metal suboxide layer or metal oxide layer, and metal derived from the metal layer is exposed,” as described in (1) to (3) above, so that a corrosion protection layer, i.e., a barrier layer is formed. The corrosion protection layer can protect the very small metal sites from external environmental factors such as oxygen, water, and chloride ions. Moreover, the layer of the protective layer that is located on the outermost side includes the resin containing a fluorine atom and a siloxane bond. Therefore, not only the anti-stick properties and ease of wiping of the surface of the protective layer against human sebum, but also water repellency can be improved. This can further reduce the influence of the external environmental factors such as water and chloride ions on the very small metal sites. Because of these synergistic effects, it may be possible to significantly suppress the progress of corrosion and degradation of the metal layer, even if the protective layer is made thin to reduce the thermal transmittance and improve the heat insulation properties. Thus, the transparent heat-shielding/heat-insulating member of this embodiment can have a high visible light transmittance, a low shading coefficient, a low thermal transmittance, and a low solar absorptance. Moreover, the transparent heat-shielding/heat-insulating member can also suppress corrosion and degradation caused by, e.g., water condensation and adhesion of human sebum.

Hereinafter, each of the constituent members of the transparent heat-shielding/heat-insulating member of this embodiment will be described.

<Transparent Base Substrate>

The transparent base substrate of the transparent heat-shielding/heat-insulating member of this embodiment is not particularly limited as long as it is made of a material with translucency. The transparent base substrate may be a film or sheet made of resin. Examples of the resin include the following: polyester resins (such as polyethylene terephthalate and polyethylene naphthalate); polycarbonate resins; polyacrylic acid ester resins (such as polymethyl methacrylate); polyolefin resins; polystyrene resins (such as polystyrene and acrylonitrile-styrene copolymers); polyvinyl chloride resins; polyvinyl acetate resins; polyether sulfone resins; cellulose resins (such as diacetyl cellulose and triacetyl cellulose); and norbornene resins. The resin can be formed into a film or sheet by, e.g., an extrusion method, a calendar molding method, a compression molding method, an injection molding method, or a method in which the resin is dissolved in a solvent and then casted. Any additives such as an antioxidant, a flame retardant, a heat stabilizer, an ultraviolet absorber, a lubricant, and an antistatic agent may be added to the resin. The thickness of the transparent base substrate is, e.g., 10 to 500 μm, and is preferably 25 to 125 μm in view of processability and cost.

<Infrared Reflective Layer>

The infrared reflective layer of the transparent heat-shielding/heat-insulating member of this embodiment includes a first metal suboxide layer or metal oxide layer, a metal layer, and a second metal suboxide layer or metal oxide layer in this order from the transparent base substrate side. The total thickness of the infrared reflective layer is 25 nm or less. The thickness of the second metal suboxide layer or metal oxide layer is set to 25% or less of the total thickness of the infrared reflective layer. The lower limit of the total thickness of the infrared reflective layer is preferably 7 nm or more to perform the functions (i.e., heat shielding performance and heat insulation performance) of the infrared reflective layer. If the total thickness of the infrared reflective layer is less than 7 nm, the infrared reflectance is reduced, the shading coefficient and the thermal transmittance are increased, and thus the heat shielding performance and the heat insulation performance may be degraded.

Due to the presence of the infrared reflective layer, the transparent heat-shielding/heat-insulating member can have a heat shielding function and a heat insulation function. In the transparent heat-shielding/heat-insulating member, since the total thickness of the infrared reflective layer is set to 25 nm or less, the visible light transmittance can easily be set to 60% or more. If the total thickness of the infrared reflective layer is more than 25 nm, the visible light transmittance is reduced, and thus the transparency may be degraded.

Moreover, the thickness of the second metal suboxide layer or metal oxide layer is set to 25% or less of the total thickness of the infrared reflective layer. Therefore, the metal layer, which greatly contributes to the infrared reflective function, can be relatively thick in the range of the total thickness of the infrared reflective layer. This makes it possible to increase the infrared reflectance and reduce the shading coefficient and the thermal transmittance.

Further, as the thickness of the metal layer is increased, the first metal suboxide layer or metal oxide layer and the second metal suboxide layer or metal oxide layer can be relatively thin so that their thicknesses are 25% or less of the total thickness of the infrared reflective layer, respectively. While it is difficult to make sweeping statements about the solar radiation characteristics (including solar transmittance, solar reflectance, and solar absorptance) of the infrared reflective layer formed on the transparent base substrate, because they may differ depending on the types of metals, metal suboxides, and metal oxides that are to be used, the infrared reflective layer of this embodiment has the following properties, as compared to an infrared reflective layer in which the metal layer has the same thickness, but the first metal suboxide layer or metal oxide layer and the second metal suboxide layer or metal oxide layer each have a thickness greater than the above range of this embodiment.

Specifically, (A) the solar transmittance tends to be low at a wavelength of 380 to 780 nm and tends to be high at a wavelength of 790 to 2500 nm, (B) the solar reflectance tends to be high at a wavelength of 380 to 780 nm and tends to be low at a wavelength of 790 to 2500 nm, and (C) the sum of the solar transmittance and the solar reflectance tends to be high. In other words, the solar absorptance, which is obtained by subtracting the solar transmittance and the solar reflectance from 100%, tends to be low. When a protective layer (as will be described later) is further provided on the infrared reflective layer with these solar radiation characteristics, the balance between the solar transmittance and the solar reflectance can be controlled at a high level, resulting in a heat-shielding/heat-insulating member having a relatively low solar absorptance. Thus, if such an infrared reflective film is applied to window glass, it can suppress a temperature rise near the center of the window glass and reduce the risk that the window glass will be thermally cracked, as compared to the conventional infrared reflective film with heat insulation properties.

On the other hand, when the thickness of the second metal suboxide layer or metal oxide layer is small, i.e., 25% or less of the total thickness of the infrared reflective layer, although the heat insulation performance is improved, it becomes difficult to completely cover the metal layer with the second metal suboxide layer or metal oxide layer. This may lead to the “very small metal sites where the metal layer is not completely covered with the second metal suboxide layer or metal oxide layer, and metal derived from the metal layer is exposed,” as described in (1) to (3) above. Therefore, in general, the inherent protective function of the second metal suboxide layer or metal oxide layer for the metal layer is reduced, and the metal layer, which greatly contributes to the infrared reflective function, is susceptible to corrosion and degradation in the harsh operating environment. However, in the transparent heat-shielding/heat-insulating member of this embodiment, as described above, the corrosion inhibitor for metal is included in at least the layer of the protective layer (composed of a single layer or multiple layers) that is in contact with the second metal suboxide layer or metal oxide layer of the infrared reflective layer. More preferably, the layer of the protective layer that is located on the outermost side includes the resin containing a fluorine atom and a siloxane bond. This configuration can significantly suppress the progress of corrosion and degradation of the metal layer.

Examples of more specific aspects of the infrared reflective layer includes the following: (A) transparent base substrate first metal suboxide layer/metal layer/second metal suboxide layer; (B) transparent base substrate/first metal oxide layer metal layer/second metal suboxide layer; (C) transparent base substrate/first metal suboxide layer/metal layer/second metal oxide layer; and (D) transparent base substrate/first metal oxide layer/metal layer second metal oxide layer. Any of these configurations may be selected in accordance with the main purpose. For example, to further improve the effects of increasing the resistance to corrosion and degradation of the metal layer and reducing the solar absorptance of the infrared reflective layer, the configurations (A) to (C) including at least the metal suboxide layer are preferred, and the configurations (A), (B) including the second metal suboxide layer formed on the metal layer are more preferred. Moreover, to increase the visible light transmittance as much as possible, the configurations (B) to (D) including at least the metal oxide layer are preferred.

A hard coat layer, an adhesion improving layer, or the like may be provided between the infrared reflective layer and the transparent base substrate. When the hard coat layer is used, it may be made of common hard coating materials. In particular, LTV curable hard coating materials are preferred that include, e.g., acrylic oligomers and polymers having low shrinkage properties and flex resistance. The use of these hard coating materials can reduce the risk of impairing the function of the infrared reflective layer and the resistance to corrosion and degradation of the metal layer. This is because, e.g., even if a heat-shielding/heat-insulating film is accidentally folded, bent, or dented in the process of applying the film to window glass, microcracks are less likely to occur in the hard coat layer, and therefore are also less likely to occur in the infrared reflective layer that is formed on the hard coat layer. The thickness of the hard coat layer is preferably 0.3 to 2.0 μm, and more preferably 0.5 to 1.0 μm.

The metal layer includes metal as the main component. Common metal materials having a high electrical conductivity and excellent far infrared reflective performance such as silver (refractive index n=0.12), copper (n=0.95), gold (n=0.35), and aluminum (n=0.96) may be appropriately used. Among them, silver is preferred because it absorbs a relatively small amount of visible light and has a higher electrical conductivity than any other metal. Specifically, metal materials containing at least 90% by mass of silver are preferred. Moreover, alloys containing at least one or more of palladium, gold, copper, aluminum, bismuth, nickel, niobium, magnesium, and zinc may also be used to improve the corrosion resistance. The metal layer can be obtained by forming the above materials into a film with a dry coating method such as a sputtering method, a vapor deposition method, or a plasma CVD method. In terms of the balance between the visible light transmittance and the infrared reflectance, the thickness of the metal layer is preferably 5 to 20 nm, and more preferably 8 to 16 nm per layer. If the thickness of the metal layer is less than 5 nm, the infrared reflectance is reduced, the shading coefficient and the thermal transmittance are increased, and thus the heat shielding performance and the heat insulation performance may be degraded. If the thickness of the metal layer is more than 20 nm, the visible light transmittance is reduced, and thus the transparency may be degraded.

The first metal suboxide layer or metal oxide layer and the second metal suboxide layer or metal oxide layer are provided above and below the metal layer as an optical compensation layer and a protective layer for the metal layer, respectively. In the first metal suboxide layer or metal oxide layer and the second metal suboxide layer or metal oxide layer, the term “metal suboxide” means a partial oxide (incomplete oxide) having a lower content of oxygen element than a complete oxide in accordance with the stoichiometric composition of metal. The term “metal oxide” means an oxide in accordance with the stoichiometric composition of metal. The metal suboxide layer does not necessarily have to include only the partial oxide having a lower content of oxygen element than the complete oxide in accordance with the stoichiometric composition of metal. For example, the metal suboxide layer may be composed of an oxidized layer that is formed by oxidation according to the stoichiometric composition and an unoxidized layer that remains without being oxidized. Specifically the side of the metal suboxide layer that comes into direct contact with the metal layer may be the unoxidized layer (which remains to be a metal layer) and the opposite side of the metal suboxide layer may be the oxidized layer.

The metal suboxide layer with a predetermined thickness (as will be described later) is provided on both or either of the upper and lower surfaces of the metal layer. This can increase the resistance to corrosion and degradation of the metal layer and simultaneously reduce the solar absorptance of the infrared reflective layer at a high level. Examples of the metal suboxide include partial oxides of metals such as titanium, nickel, chromium, cobalt, indium, tin, niobium, zirconium, zinc, tantalum, aluminum, cerium, magnesium, silicon, and mixtures thereof. Among them, in view of a dielectric that is relatively transparent to visible light and has a high refractive index, the metal suboxide is preferably a partial oxide of titanium metal or a partial oxide of metal composed mainly of titanium. That is, the metal suboxide preferably contains a titanium component.

The method for forming the metal suboxide layer is not particularly limited and may be, e.g., a reactive sputtering method. Specifically, films are formed by sputtering using the above metals as targets in an atmospheric gas containing an inert gas such as argon gas and an oxidizing gas such as oxygen at an appropriate concentration (which is lower than the oxidizing gas concentration for the formation of metal oxide films). As a result, a metal partial (incomplete) oxide layer including the oxygen element that corresponds to the oxidizing gas concentration, namely the metal suboxide layer can be formed. Moreover, using a reducing oxide, which is an oxide deficient in oxygen relative to the stoichiometric composition of metal, as a target, the metal suboxide layer can also be formed by sputtering in an inert gas atmosphere. Alternatively, a metal thin film or a partially oxidized metal thin film may be formed by, e.g., sputtering and then post-oxidized by e.g., heat treatment or exposure to the atmosphere, so that the metal suboxide layer can be formed. In order to suppress the oxidation of the metal layer by the oxidizing gas and ensure productivity it is preferable that the metal suboxide layer is formed on the metal layer in the following manner. First, a metal thin film is formed by sputtering using only the metal contained in the metal suboxide as a target, while the atmospheric gas contains only an inert gas. Then, the surface of the metal thin film is exposed to the atmosphere and post-oxidized, resulting in the metal suboxide layer.

A preferred aspect of the method for forming the metal suboxide layer in this embodiment is as follows. Specifically first, a first metal thin film that corresponds to a precursor of the first metal suboxide layer is formed on the transparent base substrate by sputtering using only the metal contained in the first metal suboxide layer as a target in an inert gas atmosphere. Then, the metal layer is continuously formed on the first metal thin film by sputtering using metal such as silver as a target without breaking the vacuum. Finally, a second metal thin film that corresponds to a precursor of the second metal suboxide layer is continuously formed on the metal layer by sputtering using only the metal contained in the second metal suboxide layer as a target without breaking the vacuum. Subsequently, these layers are wound into a roll, and then the roll is unwound with exposure to the atmosphere so that the surface of the second metal thin film is slowly oxidized. Thus, the second metal thin film is transformed to the second metal suboxide layer. In this case, when the first metal thin film is formed on the transparent base substrate by sputtering, the surface of the first metal thin film that is in contact with the transparent base substrate may be slowly oxidized by a small amount of outgas generated from the transparent base substrate, and thus the first metal thin film may be transformed to the first metal suboxide layer. Further, in this case, both the surface of the first metal suboxide layer and the surface of the second metal suboxide layer that are in direct contact with the metal layer (e.g., silver) are considered to constitute unoxidized layers (metal layers). These unoxidized layers (metal layers) can help improve the function of protecting the metal layer (e.g., silver) from external environmental factors such as oxygen, water, and chloride ions, as much as possible.

The metal oxide with a predetermined thickness (as will be described later) is provided on both or either of the upper and lower surfaces of the metal layer. This can increase the visible light transmittance and simultaneously reduce the solar absorptance of the infrared reflective layer, Examples of the metal oxide include indium tin oxide (refractive index n=1.92), indium zinc oxide (n=2.00), indium oxide (n=2.00), titanium oxide (n=2.50), tin oxide (n=2.00), zinc oxide (n=2.03), niobium oxide (n=2.30), and aluminum oxide (n=1.77). The metal oxide layer can be obtained by forming the above materials into a film with a dry coating method such as a sputtering method, a vapor deposition method, or an ion plating method. Moreover, using the metals of these metal oxides as targets, the metal oxide layer may be formed by a reactive sputtering method with an atmospheric gas where the concentration of an oxidizing gas is increased sufficiently.

When the metal suboxide layer is formed of a partial oxide (TiOₓ) layer of titanium (Ti) metal, x of the TiOₓ in this layer is preferably 0.5 or more and less than 2.0 to further improve the effects of increasing the resistance to corrosion and degradation of the metal layer and reducing the solar absorptance of the infrared reflective layer, and also to keep the balance with the visible light transmittance. If x of the TiOₓ is less than 0.5, the visible light transmittance of the infrared reflective layer is reduced, and thus the transparency may be degraded, although the effects of increasing the resistance to corrosion and degradation of the metal layer and reducing the solar absorptance of the infrared reflective layer are improved. If x of the TiOₓ is 2.0 or more, the effects of increasing the resistance to corrosion and degradation of the metal layer and reducing the solar absorptance of the infrared reflective layer may be reduced, although the visible light transmittance of the infrared reflective layer is increased. In this case, x of the TiOₓ can be analyzed and calculated by, e.g., energy-dispersive X-ray fluorescence analysis (EDX).

The thickness of the metal suboxide layer is preferably 1 to 6 nm. When the thickness is within this range, it is possible to further improve the effects of increasing the resistance to corrosion and degradation of the metal layer and reducing the solar absorptance of the infrared reflective layer, and also to keep the balance with the visible light transmittance. The thickness of the metal oxide layer is preferably 1 to 6 nm. When the thickness is within this range, it is possible to keep the balance between the effect of reducing the solar absorptance of the infrared reflective layer and the visible light transmittance. If the thickness of the metal suboxide layer or the metal oxide layer is less than 1 nm, there are growing risks of not only reducing the protective function for the metal layer, but also increasing the number of the “very small metal sites where the metal layer is not completely covered with the second metal suboxide layer or metal oxide layer, and metal derived from the metal layer is exposed,” so that the metal layer may not have sufficient resistance to corrosion and degradation. Moreover, the visible light transmittance is reduced, and thus the transparency may be degraded. If the thickness of the metal suboxide layer or the metal oxide layer is more than 6 nm, the solar absorptance may be increased, particularly for the metal oxide layer.

<Protective Layer>

The protective layer of the transparent heat-shielding/heat-insulating member of this embodiment is composed of a single layer or multiple layers. At least the layer of the protective layer that is in contact with the second metal suboxide layer or metal oxide layer of the infrared reflective layer includes a corrosion inhibitor for metal. More preferably, the layer of the protective layer that is located on the outermost side includes a resin containing a fluorine atom and a siloxane bond. Since the corrosion inhibitor for metal is included in the layer of the protective layer that is in contact with the second metal suboxide layer or metal oxide layer, even if the second metal suboxide layer or metal oxide layer is made thin to reduce the solar absorptance of a low emissivity film, the corrosion inhibitor for metal is adsorbed on the “very small metal sites where the metal layer is not completely covered with the second metal suboxide layer or metal oxide layer, and metal derived from the metal layer is exposed,” so that a corrosion protection layer is formed. The corrosion protection layer can protect the very small metal sites from external environmental factors such as oxygen, water, and chloride ions. Thus, it is possible to significantly suppress the progress of corrosion and degradation of the metal layer. Moreover, the layer of the protective layer that is located on the outermost side includes the resin containing a fluorine atom and a siloxane bond, Therefore, not only the anti-stick properties and ease of wiping of the surface of the protective layer against human sebum, but also water repellency can be improved. This can further reduce the influence of the external environmental factors such as water and chloride ions on the very small metal sites. Thus, it is also possible to suppress the progress of corrosion and degradation of the metal layer.

The type of the corrosion inhibitor for metal is not particularly limited, and any compound that can suppress the corrosion of metal may be used. In particular, compounds capable of suppressing the corrosion of silver are preferred, and compounds having a functional group that is easily adsorbed on silver are also preferred. Examples of the corrosion inhibitor include the following: amines and derivatives thereof compounds with a pyrrole ring; compounds with a triazole ring; compounds with a pyrazole ring; compounds with an imidazole ring; compounds with an indazole ring; guanidines and derivatives thereof; compounds with a thiazole ring; thioureas; compounds with a mercapto group; thioethers; naphthalene compounds; copper chelate compounds; and silicone-modified resins. Among them, compounds having a nitrogen-containing group and compounds having a sulfur-containing group are particularly preferred. The corrosion inhibitor may be preferably selected from at least one of these compounds and mixtures thereof.

Examples of the compounds having a nitrogen-containing group include the following: alkyl alcohol amine derivatives such as amino alcohol, methyl ethanol amine, dimethyl amino ethanol, and N,N-dimethyl ethanol amine; phenyl amine derivatives such as diphenyl amine, alkylated diphenyl amine, and phenylene diamine; guanidine derivatives such as guanidine, 1-o-tolylbiguanide, 1-phenylguanidine, and aminoguanidine; triazoles and derivatives thereof such as 1,2,3-triazole, 1,2,4-triazole, benzotriazole, and 1-hydroxybenzotriazole; pyrrole derivatives such as N-butyl-2,5-dimethylpyrrole and N-phenyl-2,5-dimethylpyrrole; pyrazoles and derivatives thereof such as pyrazole, pyrazoline, pyrazolone, pyrazolidine, pyrazolidone, 3,5-dimethylpyrazole, 3-methyl-5-hydroxypyrazole, and 4-aminopyrazole; imidazoles and derivatives thereof such as imidazole, histidine, 2-heptadecylimidazole, and 2-methylimidazole; and indazoles and derivatives thereof such as 4-chloroindazole, 4-nitroindazole, 5-nitroindazole, and 4-chloro-5-nitroindazole.

Examples of the compounds having a sulfur-containing group include the following: thiol derivatives such as alkanethiol and alkyl disulfide; thioglycerols and derivatives thereof such as 1-thioglycerol; thioglycols and derivatives thereof such as 2-hydroxyethanethiol; thiobenzoic acids and derivatives thereof, multifunctional thiol monomers such as pentaerythritol-tetrakis(3-mercaptobutyrate), 1,4-bis(3-mercaptobutryloxy) butane, trimethylolpropane-tris(3-mercaptobutyrate), and trimethylolethane-tris(3-mercaptobutyrate); thiophenol; glycol dimercaptoacetate; and 3-mercaptopropyltrimethoxysilane.

Examples of the compounds having both the nitrogen-containing group and the sulfur-containing group include the following: mercaptotriazoles and derivatives thereof such as 3-mercapto-1,2,4-triazole and 1-methyl-3-mercapto-1,2,4-triazole; mercaptothiazoles and derivatives thereof such as 2-mercaptobenzothiazole; mercaptoimidazoles and derivatives thereof such as 2-mercaptobenzimidazole; mercaptotriazines and derivatives thereof such as 2,4-dimercaptotriazine; thioureas and derivatives thereof such as thiourea and guanylthiourea; aminothiophenols and derivatives thereof such as 2-aminothiophenol and 4-aminothiophenol; and 2-mercapto-N-(2-naphthyl) acetamide.

The content of the corrosion inhibitor for metal is preferably 1% by mass or more and 20% by mass or less of the total mass of a layer including the corrosion inhibitor for metal. If the content is less than 1% by mass, the corrosion inhibitor is unlikely to exhibit its effect as an additive. If the content is more than 20% by mass, the strength of the protective layer that is in contact with the second metal suboxide layer or metal oxide layer and the strength of other layers including the corrosion inhibitor may be reduced, and the adhesion properties at the interface between the layers may also be reduced.

The corrosion inhibitor for metal is included in at least the layer of the protective layer (composed of a single layer or multiple layers) that is in contact with the second metal suboxide layer or metal oxide layer of the infrared reflective layer. This is because the corrosion inhibitor for metal can be adsorbed on the “very small metal sites where the metal layer is not completely covered with the second metal suboxide layer or metal oxide layer, and metal derived from the metal layer is exposed,” and can form a corrosion protection layer on the surface of the infrared reflective layer with the highest efficiency. Consequently, even if the “very small metal sites where the metal layer is not completely covered with the second metal suboxide layer or metal oxide layer, and metal derived from the metal layer is exposed” occur when the second metal suboxide layer or metal oxide layer is made thin to reduce the solar absorptance of a low emissivity film, the corrosion inhibitor will be adsorbed on the very small metal sites to form a corrosion protection layer. The corrosion protection layer serves as a barrier layer to protect the very small metal sites from external environmental factors such as oxygen, water, and chloride ions that have penetrated and diffused into the protective layer. Thus, it is possible to significantly suppress the progress of corrosion and degradation of the metal layer caused by the “very small metal sites where the metal layer is not completely covered with the second metal suboxide layer or metal oxide layer, and metal derived from the metal layer is exposed,” which has been a conventional problem.

The protective layer is composed of a single layer or multiple layers formed on the infrared reflective layer. Specifically the protective layer includes, e.g., 1 to 4 layers. Of these layers, at least the layer that is in contact with the second metal suboxide layer or metal oxide layer of the infrared reflective layer includes the corrosion inhibitor for metal. When the protective layer is composed of a single layer, a medium refractive index layer or a low refractive index layer may be provided on the second metal suboxide layer or metal oxide layer of the infrared reflective layer. In this case, the corrosion inhibitor for metal is included in the medium refractive index layer or the low refractive index layer. When the protective layer is composed of two layers, a high refractive index layer and a low refractive index layer may be provided in this order on the second metal suboxide layer or metal oxide layer of the infrared reflective layer. In this case, the corrosion inhibitor for metal may be included in at least the high refractive index layer, and may also be included in, e.g., all the layers. When the protective layer is composed of three layers, a medium refractive index layer, a high refractive index layer, and a low refractive index layer may be provided in this order on the second metal suboxide layer or metal oxide layer of the infrared reflective layer. In this case, the corrosion inhibitor for metal may be included in at least the medium refractive index layer, and may also be included in, e.g., all the layers. When the protective layer is composed of four layers, an optical adjustment layer, a medium refractive index layer, a high refractive index layer, and a low refractive index layer may be provided in this order on the second metal suboxide layer or metal oxide layer of the infrared reflective layer. In this case, the corrosion inhibitor for metal may be included in at least the optical adjustment layer, and may also be included in, e.g., all the layers.

As described above, when a plurality of layers of the protective layer are formed on the second metal suboxide layer or metal oxide layer of the infrared reflective layer, the corrosion inhibitor for metal is included in at least the layer that is in contact with the second metal suboxide layer or metal oxide layer. Moreover, the corrosion inhibitor for metal may also be included in the other layers. The reason for this is as follows. For example, assuming that the layer including the corrosion inhibitor, which is to be a first layer of the above protective layer, is formed by wet coating, if the wet coating solution was repelled by the “very small metal sites where the metal layer is not completely covered with the second metal suboxide layer or metal oxide layer, and metal derived from the metal layer is exposed,” and failed to cover the surface of the very small metal sites, the corrosion inhibitor could not be successfully adsorbed on the very small metal sites. Even in such a case, when a second layer of the protective layer includes the corrosion inhibitor and is formed on the first layer by wet coating, there is a chance that the corrosion inhibitor may be adsorbed again on the very small metal sites where no corrosion inhibitor has yet been adsorbed due to insufficient covering. In this manner, it is possible to significantly reduce the residual rate of the very small metal sites on which no corrosion inhibitor has been adsorbed.

In this embodiment, it is more preferable that the layer of the protective layer that is located on the outermost side includes a resin containing a fluorine atom and a siloxane bond. When the protective layer is composed of a single layer, the medium refractive index layer or the low refractive index layer is located on the outermost side, as described above. Therefore, in this case, the medium refractive index layer or the low refractive index layer includes the resin containing a fluorine atom and a siloxane bond. When the protective layer includes 2 to 4 layers, the low refractive index layer is located on the outermost side, as described above. Therefore, in this case, the low refractive index layer includes the resin containing a fluorine atom and a siloxane bond.

The presence of the resin containing a fluorine atom and a siloxane bond in the outermost layer can be confirmed, e.g., in the following manner. First, X-ray photoelectron spectroscopy (XPS) or gas chromatography mass spectrometry (GC/MS) may be used to check whether or not the outermost layer includes a fluorine atom. Then, gas chromatography mass spectrometry (GC/MS) may be used to check whether or not the outermost layer includes a siloxane bond.

The resin containing a fluorine atom and a siloxane bond may be preferably a copolymer resin that contains, e.g., a fluorine-containing (meth)acrylate, a silicone-modified acrylate, and an ionizing radiation curable resin as resin components before polymerization. The ionizing radiation curable resin is usually a resin that is copolymerizable with the fluorine-containing (meth)acrylate and the silicone-modified acrylate.

The type of the fluorine-containing (meth)acrylate is not particularly limited, and (meth)acrylate having a perfluoroalkyl chain or the like may be suitably used. Specific examples of the fluorine-containing (meth)acrylate includes the following: “OPTOOL (registered trademark) DAC-HP” manufactured by DAIKIN INDUSTRIES, LTD.; “MEGAFACE (registered trademark) RS-75” manufactured by DIC Corporation; “Fomblin (registered trademark) AD40,” “Fomblin MT70,” “Fluorolink (registered trademark) MD700,” and “Fluorolink AD1700” manufactured by Solvay Specialty Polymers Japan K.K.; and “LING-3A (trade name)” and “LINC-102A. (trade name)” manufactured by Kyoeisha Chemical Co., Ltd.

The content of the fluorine-containing (meth)acrylate is preferably 4% by mass or more and 20% by mass or less of the total mass of the resin components before polymerization (i.e., a resin composition before polymerization). If the content is less than 4% by mass, there is a possibility that the anti-stick properties of the surface of the outermost layer against human sebum cannot be sufficiently improved, or the water repellency will not be sufficiently improved. If the content is more than 20% by mass, the scratch resistance of the outermost layer may be reduced.

The type of the silicone-modified acrylate is not particularly limited, and polyether-modified polydimethylsiloxane having an acrylic group, polyester-modified polydimethylsiloxane having an acrylic group, or the like may be suitably used. Specific examples of the silicone-modified acrylate include the following: “TEGO Rad (registered trademark) 2300,” “TEGO Rad 2500,” “TEGO Rad 2650,” and “TEGO Rad 2700” manufactured by Evonik Degussa Japan Co., Ltd.; and “BYK (registered trademark) UV 3500,” “BYK-UV 3530,” and “BYK-UV 3570” manufactured by BYK Japan K.K.

The content of the silicone-modified acrylate is preferably 1% by mass or more and 5% by mass or less of the total mass of the resin components before polymerization (i.e., a resin composition before polymerization). If the content is less than 1% by mass, there is a possibility that the ease of wiping human sebum from the surface of the outermost layer will not be sufficiently improved, or the water repellency will not be sufficiently improved. If the content is more than 5% by mass, orange peel or slight whitening is likely to occur on the surface of the outermost layer, which may lead to poor surface properties.

The ionizing radiation curable resin copolymerizable with the fluorine-containing (meth)acrylate and the silicone-modified acrylate has two or more unsaturated groups (polymerizable carbon-carbon double bond groups) that are copolymerizable with the fluorine-containing (meth)acrylate and the silicone-modified acrylate. Examples of the functional group include radical polymerizable functional groups such as (meth)acryloyl group and (meth)acryloyloxy group, and cationic polymerizable functional groups such as epoxy group, vinyl ether group, and oxetane group.

As the ionizing radiation curable resin copolymerizable with the fluorine-containing (meth)acrylate and the silicone-modified acrylate, e.g., a polyfunctional (meth)acrylate monomer and a polyfunctional (meth)acrylate oligomer (prepolymer) may be suitably used. They can be used alone or in combination. Specific examples of the ionizing radiation curable resin include the following: acrylates such as ethylene glycol di(meth)acrylate, diethylene glycol di(meth)acrylate, triethylene glycol di(meth)acrylate, 1,4-cyclohexanediacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, and 1,2,3-cyclohexanetrimethacrylate; vinylbenzene and derivatives thereof such as 1,4-divinylbenzene, 4-vinylbenzoic acid-2-acryloylethyl ester, and 1,4-divinylcyclohexanone; urethane-based polyfunctional acrylate oligomers such as pentaerythritol triacrylate hexamethylene diisocyanate urethane prepolymer; ester-based polyfunctional acrylate oligomers produced from polyhydric alcohol and (meth)acrylic acid; and epoxy-based polyfunctional acrylate oligomers and fluorine-containing compounds thereof. A photopolymerization initiator may be added as needed, and the ionizing radiation curable resin is cured together with the fluorine-containing (meth)acrylate and the silicone-modified acrylate by irradiation with ionizing radiation to form the outermost layer of the protective layer.

The content of the ionizing radiation curable resin copolymerizable with the fluorine-containing (meth)acrylate and the silicone-modified acrylate is preferably 75% by mass or more and 95% by mass or less of the total mass of the resin components before polymerization (i.e., a resin composition before polymerization). If the content is less than 75% by mass, the scratch resistance of the outermost layer may be reduced. If the content is more than 95% by mass, there is a possibility that the anti-stick properties of the surface of the outermost layer against human sebum cannot be sufficiently improved, or the ease of wiping human sebum from the surface of the outermost layer will not be sufficiently improved.

In terms of the balance between the scratch resistance, optical properties, and appearance an iris phenomenon and a change in reflected color depending on the viewing angle) of the heat-shielding/heat-insulating member, it is preferable that the protective layer includes two layers, i.e., a high refractive index layer and a low refractive index layer in this order on the infrared reflective layer, rather than including a single layer. It is more preferable that the protective layer includes three layers, i.e., a medium refractive index layer, a high refractive index layer, and a low refractive index layer in this order on the infrared reflective layer. It is most preferable that the protective layer includes four layers, i.e., an optical adjustment layer, a medium refractive index layer, a high refractive index layer, and a low refractive index layer in this order on the infrared reflective layer. When the protective layer is a single layer made of a normal acrylic ultraviolet (UV) curable hard coat resin and is formed on the infrared reflective layer, the visible light reflectance tends to vary greatly as the wavelength increases, particularly in the range of 500 nm to 780 nm of the visible light reflection spectrum. Consequently, iris patterns can occur or the reflected color can change significantly depending on the viewing angle, taking into account a thickness variation of the protective layer. In particular, if the thickness of the protective layer is reduced in the range that overlaps the visible wavelength range of 380 to 780 nm in order to reduce the thermal transmittance and improve the heat insulation performance, the above phenomenon becomes prominent due to the effect of the interference of multiple reflection. However, when the protective layer includes a plurality of layers with different refractive indices, even if the thickness of the protective layer is reduced in the range that overlaps the visible wavelength range of 380 to 780 nm, it is possible to reduce the variation in visible light reflectance according to the wavelength of the visible light reflection spectrum, and also to suppress the occurrence of iris patterns and the change in reflected color depending on the viewing angle.

The total thickness of the protective layer is preferably 980 nm or less in terms of reducing the thermal transmittance, which is an indicator of the heat insulation performance of the heat-shielding/heat-insulating member. Further, in view of the scratch resistance and the resistance to corrosion and degradation, the total thickness of the protective layer is more preferably 200 to 980 nm. If the total thickness of the protective layer is less than 200 nm, physical properties such as the scratch resistance and the resistance to corrosion and degradation may be reduced. If the total thickness of the protective layer is more than 980 nm, the protective layer absorbs a larger amount of far infrared rays with a wavelength of 5.5 μm to 25.2 μm and has a higher normal emissivity because of, e.g., the influence of C═O groups, C—O groups, and aromatic groups contained in the molecular skeleton of the resin used for the optical adjustment layer, the medium refractive index layer, the high refractive index layer, and the low refractive index layer, or the influence of inorganic oxide fine particles used to adjust the refractive index of each layer. Consequently, the heat insulation performance may be degraded. When the total thickness of the protective layer is 200 to 980 nm, the thermal transmittance can be reduced to 4.2 W/(m²·K) or less, and the heat insulation performance can be sufficiently achieved. The total thickness of the protective layer is most preferably 300 to 700 nm, where the total thickness is 300 nm or more in terms of further improving the scratch resistance and the resistance to corrosion and degradation, and the total thickness is 700 nm or less in terms of further reducing the thermal transmittance. When the total thickness of the protective layer is 300 to 700 nm, the thermal transmittance can be reduced to 4.0 W/(m²·K) or less, and the heat insulation performance is compatible with physical properties such as the scratch resistance and the resistance to corrosion and degradation at a higher level.

Hereinafter, each layer of the protective layer will be described.

[Optical Adjustment Layer]

The optical adjustment layer adjusts the optical properties of the infrared reflective layer of the transparent heat-shielding/heat-insulating member of this embodiment. The refractive index of the optical adjustment layer is preferably 1.60 to 2.00, and more preferably 1.65 to 1.90 at a wavelength of 550 nm. While it is difficult to make sweeping statements about the thickness of the optical adjustment layer when the protective layer includes a plurality of layers, because an appropriate range of the thickness may differ depending on, e.g., the refractive index and thickness of each of the layers, including the medium refractive index layer, the high refractive index layer, and the low refractive index layer, which are formed in this order on the optical adjustment layer, the thickness of the optical adjustment layer is preferably 30 to 80 nm, and more preferably 35 to 70 nm in consideration of the configuration of the other layers. When the thickness of the optical adjustment layer is 30 to 80 nm, the visible light transmittance and the near infrared reflectance of the transparent heat-shielding/heat-insulating member of this embodiment are compatible with a high balance. If the thickness of the Optical adjustment layer is less than 30 nm, coating itself will be difficult, and the coating solution is likely to be repelled by the “very small metal sites where the metal layer is not completely covered with the second metal suboxide layer or metal oxide layer, and metal derived from the metal layer is exposed,” and may fail to cover the surface of the very small metal sites. Thus, the corrosion inhibitor for metal cannot be successfully adsorbed on the very small metal sites. Moreover, the visible light transmittance is reduced, and thus the transparency may be degraded or the reflected color may turn reddish. If the thickness of the optical adjustment layer is more than 80 nm, the near infrared reflectance is reduced, and thus the heat insulation performance may be degraded.

The optical adjustment layer preferably includes the same kind of material as that of the second metal suboxide layer or metal oxide layer of the infrared reflective layer in terms of ensuring the adhesion properties between the optical adjustment layer and the second metal suboxide layer or metal oxide layer because they come into direct contact with each other. For example, when the second metal suboxide layer or metal oxide layer is a partial oxide layer or oxide layer of titanium metal or a partial oxide layer or oxide layer of metal composed mainly of titanium, the optical adjustment layer preferably includes a material containing titanium oxide fine particles. Since the material of the optical adjustment layer contains the titanium oxide fine particles, the refractive index of the optical adjustment layer can be appropriately controlled to a high refractive index in the range of 1.60 to 2.00. Moreover, the optical adjustment layer can have good adhesion properties to the metal suboxide layer or metal oxide layer that is formed of the partial oxide layer or oxide layer of titanium metal or the partial oxide layer or oxide layer of metal composed mainly of titanium.

The material of the optical adjustment layer that contains inorganic fine particles typified by the titanium oxide fine particles is not particularly limited as long as the refractive index of the optical adjustment layer can be set within the above range. For example, a suitable material may contain a resin such as a thermoplastic resin, a thermosetting resin, or an ionizing radiation curable resin and inorganic fine particles dispersed in the resin. In particular, the optical adjustment layer is preferably made of a material containing the ionizing radiation curable resin and inorganic fine particles dispersed in the ionizing radiation curable resin in terms of optical properties such as the transparency, physical properties such as the scratch resistance, and productivity. The material containing the ionizing radiation curable resin and the inorganic fine particles is usually applied to the surface of the second metal suboxide layer or metal oxide layer of the infrared reflective layer, and then cured by irradiation with ionizing radiation such as ultraviolet rays, thus providing the optical adjustment layer. In this case, the presence of the inorganic fine particles reduces the shrinkage of the film during curing. Therefore, the adhesion properties between the optical adjustment layer and the second metal suboxide layer or metal oxide layer can be improved.

Examples of the thermoplastic resin include modified polyolefin resin, vinyl chloride resin, acrylonitrile resin, polyamide resin, polyimide resin, polyacetal resin, polycarbonate resin, polyvinyl butyral resin, acrylic resin, polyvinyl acetate resin, polyvinyl alcohol resin, and cellulosic resin. Examples of the thermosetting resin include phenol resin, melamine resin, urea resin, unsaturated polyester resin, epoxy resin, polyurethane resin, silicone resin, and alkyd resin. These resins can be used alone or in combination. A crosslinking agent may be added as needed, and the resin is heat cured to form the optical adjustment layer.

As the ionizing radiation curable resin, e.g., a polyfunctional (meth)acrylate monomer and a polyfunctional (meth)acrylate oligomer (prepolymer) that have two or more unsaturated groups may be used. They can be used alone or in combination. Specific examples of the ionizing radiation curable resin include the following: acrylates such as ethylene glycol di(meth)acrylate, diethylene glycol di(meth)acrylate, triethylene glycol di(meth)acrylate, 1,4-cyclohexanediacrylate, pentaerythritol tetra(meth)acrylate; pentaerythritol tri(meth)acrylate, trimethylolpropane tri(meth)acrylate; trimethylolethane tri(meth)acrylate, dipentaerythritol tetra(meth)acrylate, dipentaerythritol penta(meth)acrylate, dipentaerythritol hexa(meth)acrylate, and 1,2,3-cyclohexanetrimethacrylate; vinylbenzene and derivatives thereof such as 1,4-divinylbenzene, 4-vinylbenzoic acid-2-acryloylethyl ester, and 1,4-divinylcyclohexanone; urethane-based polyfunctional acrylate oligomers such as pentaerythritol triacrylate hexamethylene diisocyanate urethane prepolymer; ester-based polyfunctional acrylate oligomers produced from polyhydric alcohol and (meth)acrylic acid; and epoxy-based polyfunctional acrylate oligomers. A photopolymerization initiator may be added as needed, and the ionizing radiation curable resin is cured by irradiation with ionizing radiation to form the optical adjustment layer.

To further improve the adhesion properties between the optical adjustment layer including the ionizing radiation curable resin and the second metal suboxide layer or metal oxide layer of the infrared reflective layer, e.g., (meth)acrylic acid derivatives having a polar group such as a phosphoric acid group, a sulfonic acid group, or an amide group and a silane coupling agent having an unsaturated group such as a (meth)acrylic group or a vinyl group may be added to the ionizing radiation curable ream.

The inorganic fine particles are added and dispersed in the resin to adjust, the refractive index of the optical adjustment layer. Examples of the inorganic fine particles include titanium oxide (TiO₂), zirconium oxide (ZrO₂), zinc oxide (ZnO), indium tin oxide (ITO), niobium oxide (Nb₂O₅), yttrium oxide (Y₂O₃), indium oxide (In₂O₃), oxide Tin (SnO₂), antimony oxide (Sb₂O₃), tantalum oxide (Ta₂O₅), and tungsten oxide (WO₃). If necessary the inorganic fine particles may be surface treated with a dispersing agent. Among the examples of the inorganic fine particles, titanium oxide and zirconium oxide are preferred because they can be added in a smaller amount and achieve a higher refractive index than other materials. Further, titanium oxide is more preferred because it absorbs a relatively small amount of light in the far infrared region and ensures the adhesion properties between the optical adjustment layer and the TiOₓ layer suitable for the metal suboxide layer.

The average particle size of the inorganic fine particles is preferably 5 to 100 nm in terms of the transparency of the optical adjustment layer, and more preferably 10 to 80 nm. If the average particle size is more than 100 nm, the transparency may be degraded due to, e.g., an increase in the haze level when the optical adjustment layer is formed. If the average particle size is less than 5 nm, it may be difficult to maintain the dispersion stability of the inorganic fine particles that are contained in a coating material for the optical adjustment layer

[Medium Refractive Index Layer]

The refractive index of the medium refractive index layer is preferably 1.45 to 1.55, and more preferably 1.47 to 1.53 for light with a wavelength of 550 nm. While it is difficult to make sweeping statements about the thickness of the medium refractive index layer when the protective layer includes a plurality of layers, because an appropriate range of the thickness may differ depending on, e.g., the refractive index and thickness of each of the layers, including the optical adjustment layer, which is disposed under the medium refractive index layer, and the high refractive index layer and the low refractive index layer, which are disposed in this order on the medium refractive index layer, the thickness of the medium refractive index layer is preferably 35 to 200 nm, and more preferably 50 to 150 nm in consideration of the configuration of the other layers. If the thickness of the medium refractive index layer is less than 35 nm, the medium refractive index layer may have poor adhesion properties to the second metal suboxide layer or metal oxide layer of the infrared reflective layer or the optical adjustment layer. Moreover, in the transparent heat-shielding/heat-insulating member, e.g., the reflected color may be more reddish, the transmitted color may be more greenish, and the total light transmittance may be lower. If the thickness of the medium refractive index layer is more than 200 nm, the absorption of light in the infrared region is increased, and thus the heat insulation properties may be reduced. Moreover, it is also not possible to sufficiently reduce the size of ripples in the visible light reflection spectrum of the transparent heat-shielding/heat-insulating member, i.e., the variation in reflectance with respect to the wavelength in the visible region. Thus, the iris patterns become noticeable and the reflected color changes significantly depending on the viewing angle, which may pose a problem in the appearance. For example, in the transparent heat-shielding/heat-insulating member, the reflected color may be more reddish, and the total light transmittance may be lower. Moreover, the absorption of light in the infrared region is increased, and thus the heat insulation properties may be reduced.

When the protective layer includes a plurality of layers, the material of the medium refractive index layer is not particularly limited as long as the refractive index of the medium refractive index layer can be set within the above range. For example, a thermoplastic resin, a thermosetting resin, or an ionizing radiation curable resin may be suitably used. In this case, specific examples of the resins such as the thermoplastic resin, the thermosetting resin, and the ionizing radiation curable resin may be the same as those used for the optical adjustment layer, and the medium refractive index layer can be formed with the same prescription as the optical adjustment layer. If necessary inorganic fine particles may be added and dispersed in the resin to adjust the refractive index. In particular, the medium refractive index layer is preferably made of a material containing the ionizing radiation curable resin in terms of optical properties such as the transparency, physical properties such as the scratch resistance, and productivity.

Among the above ionizing radiation curable resins, resins containing the urethane-based, ester-based, and epoxy-based polyfunctional (meth)acrylate oligomers (prepolymers), and an ultra-polyfunctional acrylic polymer resin having many acryloyl groups are more preferred. These resins are less susceptible to shrinkage on curing when irradiated with ionizing radiation such as ultraviolet rays. Therefore, the adhesion properties between the medium refractive index layer and the optical adjustment layer can be improved.

To further improve the adhesion properties between the medium refractive index layer including the ionizing radiation curable resin and the optical adjustment layer or the second metal suboxide layer or metal oxide layer, e.g., (meth)acrylic acid derivatives having a polar group such as a phosphoric acid group, a sulfonic acid group, or an amide group and a silane coupling agent having an unsaturated group such as a (meth)acrylic group or a vinyl group may be added to the ionizing radiation curable resin.

When the protective layer is composed of a single layer, the thickness of the medium refractive index layer is preferably 50 to 980 nm. If the thickness of the medium refractive index layer is 50 nm or more and less than 200 nm, since this range is outside the visible wavelength range, it is possible for the transparent heat-shielding/heat-insulating member to suppress the occurrence of iris patterns and the change in reflected color depending on the viewing angle, as described above. However, the scratch resistance and the resistance to corrosion and degradation are likely to be reduced. Thus, in view of the scratch resistance and the resistance to corrosion and degradation, the thickness of the medium refractive index layer is more preferably 200 to 980 nm. Nevertheless, if the thickness of the medium refractive index layer is set to overlap the visible wavelength range, it is difficult to suppress the occurrence of iris patterns and the change in reflected color depending on the viewing angle. Therefore, also in view of these points, the thickness of the medium refractive index layer is most preferably 790 to 980 nm, which is outside the visible wavelength range. In this case, the occurrence of iris patterns and the change in reflected color depending on the viewing angle can be suppressed to some extent.

When the protective layer is composed of a single layer, the medium refractive index layer preferably includes the resin containing a fluorine atom and a siloxane bond. If necessary, inorganic fine particles may be added and dispersed in the resin to adjust the refractive index of the medium refractive index layer.

[High Refractive Index Layer]

The refractive index of the high refractive index layer is preferably 1.65 to 1.95, and more preferably 1.70 to 1.90 for light with a wavelength of 550 nm. While it is difficult to make sweeping statements about the thickness of the high refractive index layer when the protective layer includes a plurality of layers, because an appropriate range of the thickness may differ depending on, e.g., the refractive index and thickness of each of the layers, including the medium refractive index layer and the optical adjustment layer, which are disposed in this order under the high refractive index layer, and the low refractive index layer, which is disposed on the high refractive index layer, the thickness of the high refractive index layer is preferably 60 to 550 nm, and more preferably 65 to 400 nm in consideration of the configuration of the other layers. If the thickness of the high refractive index layer is less than 60 nm, physical properties such as the scratch resistance of the protective layer may be reduced. If the thickness of the high refractive index layer is more than 550 nm, the absorption of light in the infrared region is increased when the high refractive index layer includes inorganic fine particles in large quantity, and thus the heat insulation properties may be reduced.

The material of the high refractive index layer is not particularly limited as long as the refractive index of the high refractive index layer can be set within the above range. For example, a suitable material may contain a resin such as a thermoplastic resin, a thermosetting resin, or an ionizing radiation curable resin and inorganic fine particles dispersed in the resin. In this case, specific examples of the resins such as the thermoplastic resin, the thermosetting resin, and the ionizing radiation curable resin and specific examples of the inorganic fine particles may be the same as those used for the optical adjustment layer, and the high refractive index layer can be formed with the same prescription as the optical adjustment layer. In particular, the high refractive index layer is preferably made of a material containing the ionizing radiation curable resin and inorganic fine particles dispersed in the ionizing radiation curable resin in terms of optical properties such as the transparency, physical properties such as the scratch resistance, and productivity. The material containing the ionizing radiation curable resin and the inorganic fine particles is usually applied to the surface of the medium refractive index layer, and then cured by irradiation with ionizing radiation such as ultraviolet rays, thus providing the high refractive index layer. In this case, the presence of the inorganic fine particles reduces the shrinkage of the film during curing. Therefore, the adhesion properties between the high refractive index layer and the medium refractive index layer can be improved.

The inorganic fine particles are added to adjust the refractive index of the high refractive index layer. Among the examples of the inorganic fine particles, titanium oxide and zirconium oxide are preferred because they can be added in a smaller amount and achieve a higher refractive index than other materials. Further, titanium oxide is more preferred because it absorbs a relatively small amount of light in the infrared region.

To further improve the adhesion properties between the high refractive index layer including the ionizing radiation curable resin and the medium refractive index layer or the second metal suboxide layer or metal oxide layer, e.g., (meth)acrylic acid derivatives having a polar group such as a phosphoric acid group, a sulfonic acid group, or an amide group and a silane coupling agent having an unsaturated group such as a (meth)acrylic group or a vinyl group may be added to the ionizing radiation curable resin.

[Low Refractive Index Layer]

The refractive index of the low refractive index layer is preferably 1.30 to 1.45, and more preferably 1.35 to 1.43 for light with a wavelength of 550 nm. While it is difficult to make sweeping statements about the thickness of the low refractive index layer when the protective layer includes a plurality of layers, because an appropriate range of the thickness may differ depending on, e.g., the refractive index and thickness of each of the layers, including the high refractive index layer, the medium refractive index layer, and the optical adjustment layer, which are disposed in this order under the low refractive index layer, the thickness of the low refractive index layer is preferably 70 to 150 nm, and more preferably 80 to 130 nm in consideration of the configuration of the other layers. If the thickness of the low refractive index layer is outside the range of 70 to 150 nm, it is not possible to sufficiently reduce the size of ripples in the visible light reflection spectrum of the transparent heat-shielding/heat-insulating member of this embodiment, i.e., the variation in reflectance with respect to the wavelength in the visible region. Thus, the iris patterns become noticeable and the reflected color changes significantly depending on the viewing angle, which may pose a problem in the appearance. Moreover, the visible light transmittance may be reduced.

When the protective layer is composed of a single layer, the thickness of the low refractive index layer is preferably 50 to 980 nm. If the thickness of the low refractive index layer is 50 nm or more and less than 200 nm, since this range is outside the visible wavelength range, it is possible for the transparent heat-shielding/heat-insulating member to suppress the occurrence of iris patterns and the change in reflected color depending on the viewing angle, as described above. However, the scratch resistance and the resistance to corrosion and degradation are likely to be reduced. Thus, in view of the scratch resistance and the resistance to corrosion and degradation, the thickness of the low refractive index layer is more preferably 200 to 980 nm. Nevertheless, if the thickness of the low refractive index layer is set to overlap the visible wavelength range, it is difficult to suppress the occurrence of iris patterns and the change in reflected color depending on the viewing angle. Therefore, also in view of these points, the thickness of the low refractive index layer is most preferably 790 to 980 nm, which is outside the visible wavelength range. In this case, the occurrence of iris patterns and the change in reflected color depending on the viewing angle can be suppressed to some extent.

The low refractive index layer is usually used as the outermost layer of the protective layer. Therefore, the resin components before polymerization of the resin constituting the low refractive index layer preferably contain a fluorine-containing (meth)acrylate, a silicone-modified acrylate, and an ionizing radiation curable resin that is copolymerizable with the fluorine-containing (meth)acrylate and the silicone-modified acrylate, as described above. If necessary inorganic fine particles may be added and dispersed in the ionizing radiation curable resin to adjust the refractive index. Preferred examples of the material of the low refractive index layer include a material containing the ionizing radiation curable resin and low refractive index inorganic fine particles dispersed in the ionizing radiation curable resin, and a material containing an organic/inorganic hybrid material in which the ionizing radiation curable resin and low refractive index inorganic fine particles are chemically bonded together.

The inorganic fine particles are added and dispersed in the resin to adjust the refractive index of the low refractive index layer. The low refractive index inorganic fine particles may be made of, e.g., silicon oxide, magnesium fluoride, or aluminum fluoride. In terms of physical properties such as the scratch resistance of the low refractive index layer that is to be the outermost surface of the protective layer, a silicon oxide material is preferred. Moreover, a hollow-type silicon oxide (hollow silica) material having a cavity inside is particularly preferred to reduce the refractive index.

The material containing the ionizing radiation curable resin and the inorganic fine particles is usually applied to the surface of the high refractive index layer, and then cured by irradiation with ionizing radiation such as ultraviolet rays, thus providing the low refractive index layer. In this case, the presence of the inorganic fine particles reduces the shrinkage of the film during curing. Therefore, the adhesion properties between the low refractive index layer and the high refractive index layer can be improved.

To further improve the adhesion properties between the low refractive index layer including the ionizing radiation curable resin and the high refractive index layer or the second metal suboxide layer or metal oxide layer, e.g., (meth)acrylic acid derivatives having a polar group such as a phosphoric acid group, a sulfonic acid group, or an amide group and a silane coupling agent having an unsaturated group such as a (meth)acrylic group or a vinyl group may be added to the ionizing radiation curable resin.

The low refractive index layer may include additives such as a leveling agent, a lubricant, an antistatic agent, and a haze-imparting agent in addition to the above materials. The content of these additives may be appropriately adjusted so as not to impair the purpose of this embodiment.

As described above, the protective layer composed of multiple layers has any of the following structures: (1) a laminated structure including the high refractive index layer and the low refractive index layer in this order from the infrared reflective layer side; (2) a laminated structure including the medium refractive index layer, the high refractive index layer, and the low refractive index layer in this order from the infrared reflective layer side; and (3) a laminated structure including the optical adjustment layer, the medium refractive index layer, the high refractive index layer, and the low refractive index layer in this order from the infrared reflective layer side. The thickness of the individual layers may be appropriately determined so that the total thickness of the protective layer falls in the range of 200 to 980 nm in each of the structures. Specifically, the thickness of the optical adjustment layer with a refractive index of 1.60 to 2.00 at a wavelength of 550 nm may be in the range of 30 to 80 nm, the thickness of the medium refractive index layer with a refractive index of 1.45 to 1.55 at a wavelength of 550 nm may be in the range of 40 to 200 nm, the thickness of the high refractive index layer with a refractive index of 1.65 to 1.95 at a wavelength of 550 nm may be in the range of 60 to 550 nm, and the thickness of the low refractive index layer with a refractive index of 1.30 to 1.45 at a wavelength of 550 nm may be in the range of 70 to 1.50 nm. Consequently, the heat-shielding/heat-insulating member can have excellent physical properties such as the scratch resistance and the resistance to corrosion and degradation, a low solar absorptance, and good appearance with reduced iris phenomenon and change in reflected color depending on the viewing angle, while maintaining the heat insulation properties (i.e., the thermal transmittance is 4.2 W/(m²·K) or less). In particular, to further reduce the solar absorptance as well as to maintain a high visible light transmittance, it is preferable that the protective layer is formed by setting the above layers so as to increase the reflectance for light of near infrared rays in the wavelength band of 800 to 1500 nm, where the weighting factor of energy is generally large.

A more preferred range of the total thickness of the protective layer is 300 to 700 nm. In this case, the thermal transmittance is reduced to 4.0 W/(m²·K) or less, and the protective layer can have sufficient mechanical, physical properties. Thus, the heat insulation performance is compatible with physical properties such as the scratch resistance and the resistance to corrosion and degradation at a higher level.

<Adhesive Layer>

In the transparent heat-shielding/heat-insulating member of this embodiment, it is preferable that an adhesive layer is provided on the surface of the transparent base substrate that is opposite to the surface on which the protective layer is formed. With this configuration, the transparent heat-shielding/heat-insulating member can easily be attached to, e.g., a transparent substrate such as window glass. The adhesive layer is preferably made of a material having a high visible light transmittance and a small refractive index difference from the transparent base substrate. For example, acrylic, polyester, urethane, rubber, and silicone resins can be used. Among them, the acrylic resin is more preferred because it has high optical transparency, a good balance between wettability and adhesive strength, high reliability with a proven track record, and a relatively low cost.

Examples of the acrylic resin (adhesive) include homopolymers or copolymers of acrylic monomers such as acrylic acid and its esters, methacrylic acid and its esters, acrylamide, and acrylonitrile, and copolymers of at least one of the above acrylic monomers and vinyl monomers such as vinyl acetate, maleic anhydride, and styrene. In particular, suitable acrylic adhesives may be obtained by copolymerization of the following monomers as appropriate: alkyl acrylate main monomers such as methyl acrylate, ethyl acrylate, butyl acrylate, and 2-ethylhexyl acrylate, which are components for developing adhesiveness; monomers such as vinyl acetate, acrylamide, acrylonitrile, styrene, and methacrylate, which are components for enhancing cohesion; and monomers having a functional group such as acrylic acid, methacrylic acid, itaconic acid, crotonic acid, maleic anhydride, hydroxylethyl methacrylate, hydroxylpropyl methacrylate, dimethylaminoethyl methacrylate, methylolacrylamide, and glycidyl methacrylate. The acrylic adhesives have a Tg (glass transition temperature) of −60° C. to −10° C. and a weight average molecular weight preferably in the range of 100,000 to 2,000,000, and more preferably in the range of 500,000 to 1,000,000. If necessary, e.g., isocyanate, epoxy, and metal chelate crosslinking agents can be used alone or in combination with the acrylic adhesives.

The thickness of the adhesive layer may be 10 to 100 μm, and more preferably 15 to 50 μm.

The adhesive layer preferably includes, e.g., a benzophenone-based, benzotriazole-based, or triazine-based ultraviolet absorber to suppress the degradation of the transparent heat-shielding/heat-insulating member due to ultraviolet rays such as sunlight. Moreover, it is preferable that a release film is provided on the adhesive layer before the transparent heat-shielding/heat-insulating member is attached to a transparent substrate and used.

<Transparent Heat-Shielding/Heat-Insulating Member>

The transparent heat-shielding/heat-insulating member with the above configuration of this embodiment can have a visible light transmittance of 60% or more, a shading coefficient of 0.69 or less, a thermal transmittance of 4.0 W/(m²·K) or less, and a solar absorptance of 20% or less by appropriately combining the designs of the infrared reflective layer and the protective layer. Moreover, a salt water resistance test is performed in the following manner. The transparent heat-shielding/heat-insulating member is immersed in a sodium chloride aqueous solution with a concentration of 5% by mass at 50° C. for 10 days. The transmittance of the transparent heat-shielding/heat-insulating member for light with a wavelength of 1100 nm of the transmission spectrum in the wavelength range of 300 to 1500 nm has been measured before the salt water resistance test, and is represented by T_{B}%. Similarly, the transmittance of the transparent heat-shielding/heat-insulating member for light with a wavelength of 1100 nm of the transmission spectrum in the wavelength range of 300 to 1500 nm is measured after the salt water resistance test, and is represented by T_{A}%. The results show that the value of T_{A}-T_{B} can be made less than 10 points.

Next, an example of the transparent heat-shielding/heat-insulating member of this embodiment will be described based on the drawings.

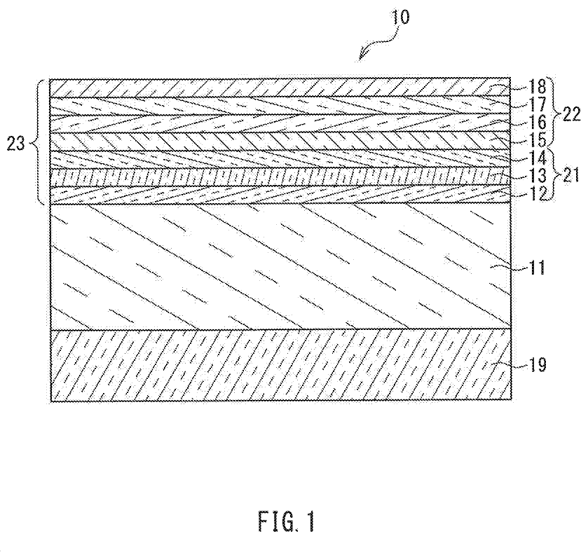

FIG. 1 is a schematic cross-sectional view showing an example of the transparent heat-shielding/heat-insulating member of this embodiment. In FIG. 1, the transparent heat-shielding/heat-insulating member 10 includes a transparent base substrate 11, a functional layer 23 including an infrared reflective layer 21 and a protective layer 22, and an adhesive layer 19. The infrared reflective layer 21 includes a first metal suboxide layer or metal oxide layer 12, a metal layer 13, and a second metal suboxide layer or metal oxide layer 14 from the transparent base substrate side. The protective layer 22 includes an optical adjustment layer 15, a medium refractive index layer 16, a high refractive index layer 17, and a low refractive index layer 18.

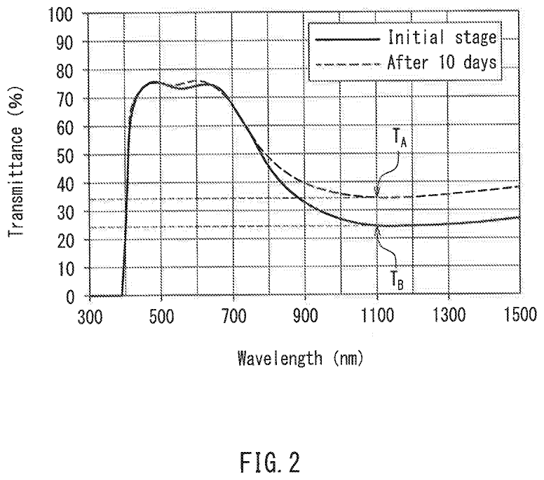

FIG. 2 is a diagram showing an example of a transmission spectrum of the transparent heat-shielding/heat-insulating member of this embodiment before and after a salt water resistance test. In the salt water resistance test, the transparent heat-shielding/heat-insulating member is immersed in a sodium chloride aqueous solution with a concentration of 5% by mass at 50° C. for 10 days. The transmittance of the transparent heat-shielding/heat-insulating member for light with a wavelength of 1100 nm of the transmission spectrum (initial stage) in the wavelength range of 300 to 1500 nm has been measured before the salt water resistance test, and is represented by T_{B}%. Similarly, the transmittance of the transparent heat-shielding/heat-insulating member for light with a wavelength of 1100 nm of the transmission spectrum (after 10 days) in the wavelength range of 300 to 1500 nm is measured after the salt water resistance test, and is represented by T_{A}%. The results show that the value of T_{A}-T_{B} can be made less than 10 points.

Due to the presence of the infrared reflective layer, the transparent heat-shielding/heat-insulating member can have a heat shielding function and a heat insulation function, while reducing the solar absorptance. Moreover, due to the presence of the protective layer, the transparent heat-shielding/heat-insulating member can improve the scratch resistance and the resistance to corrosion and degradation, and can also maintain the heat insulation function,

(Production Method of Transparent Heat-Shielding/Heat-Insulating Member)

Next, a method for producing a transparent heat-shielding/heat-insulating member according to an embodiment of the present invention will be described. The production method of the transparent heat-shielding/heat-insulating member of this embodiment includes the steps of forming an infrared reflective layer on a transparent base substrate by a dry coating method; and forming a protective layer on the infrared reflective layer by a wet coating method.

An example of the production method of the transparent heat-shielding/heat-insulting member of this embodiment is described with reference to FIG. 1.

First, the infrared reflective layer 21 is formed on one surface of the transparent base substrate 11. The infrared reflective layer 21 can be formed by a dry coating method such as sputtering of a conductive material or a transparent dielectric material, but may also be formed by other methods. The infrared reflective layer 21 preferably has a three-layer structure of the first metal suboxide layer or metal oxide layer 12, the metal layer 13, and the second metal suboxide layer or metal oxide layer 14 in terms of the heat shielding function, the heat insulation function, the resistance to corrosion and degradation, and productivity. In particular, when the first metal suboxide layer 12 and the second metal suboxide layer 14 are formed, various sputtering methods, as described above, may be preferably used. Thus, the metal suboxide layer in which the metal is partially oxidized can be formed reliably.

Next, the optical adjustment layer 15 including a corrosion inhibitor for metal is formed on the infrared reflective layer 21. Subsequently, the medium refractive index layer 16 is formed on the optical adjustment layer 15, the high refractive index layer 17 is formed on the medium refractive index layer 16, and the low refractive index layer 18 is formed on the high refractive index layer 17. These layers can be formed by a wet coating method using a coater such as die coater, comma coater, reverse coater, dam coater, doctor bar coater, gravure coater, micro-gravure coater, or roll coater. This configuration can prevent the infrared reflective layer 21 from being damaged by, e.g., window cleaning, even if the infrared reflective layer 21 is located indoors. Moreover, this configuration can improve the resistance to corrosion and degradation, suppress the angular dependence such as an iris phenomenon and a change in reflected color depending on the viewing angle in appearance, and maintain the heat insulation function of the infrared reflective layer, while further reducing the solar absorptance.

Finally, the adhesive layer 19 is formed on the other surface of the transparent base substrate 11. The method for forming the adhesive layer 19 is not particularly limited. For example, an adhesive may be directly applied to the outer surface of the transparent base substrate 11, or an adhesive sheet may be separately prepared and bonded to the outer surface of the transparent base substrate 11.

An example of the transparent heat-shielding/heat-insulating member of this embodiment can be produced by the above processes. Then, the transparent heat-shielding/heat-insulating member is attached as needed to, e.g., a glass substrate and used.

### EXAMPLES

Hereinafter, the present invention will be described in more detail by way of examples. However, the present invention is not limited to the following examples.

(Measurement of Refractive Index)

The refractive indices of the optical adjustment layer, the medium refractive index layer, the high refractive index layer, and the low refractive index layer in the following examples and comparative examples were measured in the following manner.

First, using a polyethylene terephthalate (PET) film “A4100” (trade name, thickness: 50 μm) manufactured by TOYOBO CO., LTD, in which one surface was subjected to an easy adhesion treatment, each of the coating materials for forming layers was applied to the other surface of the PET film that had not been subjected to the easy adhesion treatment so that the thickness would be 500 nm. Then, the coating materials were dried to prepare a refractive index measurement sample. When an ultraviolet curable coating material was used for each of the coating materials, the coating materials were dried and then cured by irradiation with ultraviolet rays at a light intensity of 300 mJ/cm² with a high-pressure mercury lamp, thus preparing a refractive index measurement sample.

Next, a black tape was applied to the back surface of the measurement sample thus prepared, and the reflection spectrum was measured by a reflection spectroscopy film thickness meter “FE-3000” (trade name, manufactured by Otsuka Electronics Co., Ltd.). Based on the measured reflection spectrum, fitting was performed according to the n-Cauchy equation, and thus the refractive index of each layer for light with a wavelength of 550 nm was determined.

(Measurement of Film Thickness)

The thicknesses of the optical adjustment layer, the medium refractive index layer, the high refractive index layer, and the low refractive index layer in the following examples and comparative examples were measured in the following manner. First, a black tape was applied to the surface of the transparent base substrate on which the infrared reflective layer and the protective layer were not formed, and the reflection spectrum of each layer was measured by an instantaneous multi-photometry system “MCPD-3000” (trade name, manufactured by Otsuka Electronics Co., Ltd). Based on the measured reflection spectrum, fitting was performed by optimization using the refractive index obtained by the above measurement, and thus the thickness of each layer was determined.

### Example 1

<Production of Transparent Base Substrate Provided with Infrared Reflective Layer>

First, a polyethylene terephthalate (PET) film “U483” (trade name, thickness: 50 μm) manufactured by Toray Industries, Inc., in which both surfaces were subjected to an easy adhesion treatment, was used as a transparent base substrate. Then, a first metal suboxide layer, a metal layer, and a second metal suboxide layer were formed on one surface of the PET film from the PET film side as follows. Using a titanium target, a first metal suboxide layer (TiOₓ layer) with a thickness of 2 nm was formed by a reactive sputtering method. In the reactive sputtering method, the sputtering gas was a mixed gas of Ar/O₂, and the gas flow volume ratio of Ar:O₂ was 97%:3%. Subsequently, using a silver target, a metal layer (Ag layer) with a thickness of 12 nm was formed on the first metal suboxide layer by a sputtering method. In the sputtering method, the sputtering gas was 100% Ar gas. Moreover, using a titanium target, a second metal suboxide layer (TiOₓ layer) with a thickness of 2 nm was formed on the metal layer by a reactive sputtering method. In the reactive sputtering method, the sputtering gas was a mixed gas of Ar/O₂, and the gas flow volume ratio of Ar:O₂ was 97%:3%. Thus, a PET film provided with an infrared reflective layer was produced, which had a three-layer structure of first metal suboxide (TiOₓ) layer/metal (Ag) layer/second metal suboxide (TiOₓ) layer on the PET film. In this case, x of the TiOₓ layer was 1.5.

The total thickness of the infrared reflective layer (including the first metal suboxide (TiOₓ) layer, the metal (Ag) layer, and the second metal suboxide (TiOₓ) layer) obtained by the above method was 16 nm. The ratio of the thickness of the second metal suboxide (TiOₓ) layer to the total thickness was 12.5%.

<Formation of Optical Adjustment Layer>

First, 9.60 parts by mass of a titanium oxide hard coating agent “Lioduras TYT80-01” (trade name, solid content concentration: 25% by mass, refractive index: 1.80 (nominal value)) manufactured by TOYOCHEM CO., LTD., 0.12 parts by mass (5 parts by mass with respect to the solid content of TYT80-01) of 2-mercaptobenzothiazole having a sulfur-containing group as a corrosion inhibitor for metal, and 90.28 parts by mass of methyl isobutyl ketone as a diluent solvent were mixed by a stirrer to produce an optical adjustment coating material A. Next, the optical adjustment coating material A was applied to the surface of the infrared reflective layer with a micro-gravure coater (manufactured by YASUI SEIKI CO., LTD.) so that the thickness would be 50 nm after drying. The optical adjustment coating material A was dried and then cured by irradiation with ultraviolet rays at a light intensity of 300 mJ/cm² with a high-pressure mercury lamp, thus forming an optical adjustment layer with a thickness of 50 nm. The refractive index of the optical adjustment layer was measured by the above method and found to be 1.79.

<Formation of Medium Refractive Index Layer>

First, 2.80 parts by mass of an UV curable acrylic polymer “SMP-360A” (trade name, solid content concentration: 50% by mass) manufactured by Kyoeisha Chemical Co., Ltd., 38.98 parts by mass of methyl ethyl ketone as a diluent solvent, 58.22 parts by mass of cyclohexanone, and 0.03 parts by mass of a photopolymerization initiator “Irgacure 907” (trade name) manufactured by BASF were mixed by a stirrer to produce a medium refractive index coating material A. Next, the medium refractive index coating material A was applied to the surface of the optical adjustment layer with the micro-gravure coater so that the thickness would be 60 nm after drying. The medium refractive index coating material A was dried and then cured by irradiation with ultraviolet rays at a light intensity of 300 mJ/cm² with a high-pressure mercury lamp, thus forming a medium refractive index layer with a thickness of 80 nm. The refractive index of the medium refractive index layer was measured by the above method and found to be 1.50.

<Formation of High Refractive Index Layer>

First, 20.00 parts by mass of a titanium oxide hard coating agent “Lioduras TYT80-01” (trade name, solid content concentration: 25% by mass, refractive index: 1.80 (nominal value)) manufactured by TOYOCHEM CO., LTD. and 80.00 parts by mass of methyl isobutyl ketone as a diluent solvent were mixed by a stirrer to produce a high refractive index coating material A. Next, the high refractive index coating material A was applied to the surface of the medium refractive index layer with the micro-gravure coater so that the thickness would be 90 nm after drying. The high refractive index coating material A was dried and then cured by irradiation with ultraviolet rays at a light intensity of 300 mJ/cm² with a high-pressure mercury lamp, thus forming a high refractive index layer with a thickness of 90 nm. The refractive index of the high refractive index layer was measured by the above method and found to be 1.80.

<Formation of Low Refractive Index Layer>

First, 7.32 parts by mass of a hollow silica fine particle dispersion “THRULYA 4110” (trade name, solid content concentration: 20.50% by mass) manufactured by JGC Catalysts and Chemicals Ltd., 1.20 parts by mass of pentaerythritol triacrylate “Viscoat #300” (trade name) manufactured by OSAKA ORGANIC CHEMICAL INDUSTRY LTD., 0.18 parts by mass of 1,6-hexanediol diacrylate “A-HD-N” (trade name) manufactured by Shin Nakamura Chemical Co., Ltd., 0.13 parts by mass (6.93 parts by mass with respect to the total mass of the resin composition) of a fluorine-containing urethane (meth)acrylate monomer “Fomblin MT70” (trade name, solid content concentration: 80.0% by mass) manufactured by Solvay Specialty Polymers Japan K.K., 0.02 parts by mass (1.33 parts by mass with respect to the total mass of the resin composition) of silicone-modified acrylate “TECO Rad 2650” (trade name) manufactured by Evonik Degussa Japan Co., Ltd., 0.08 parts by mass of a photopolymerization initiator “Irgacure 907” (trade name) manufactured by BASF, 60.11 parts by mass of isopropyl alcohol as a diluent solvent, 15.52 parts by mass of methyl isobutyl ketone as a diluent solvent, and 15.52 parts by mass of isopropylene glycol were mixed by a stirrer to produce a low refractive index coating material A. Next, the low refractive index coating material A was applied to the surface of the high refractive index layer with the micro-gravure coater so that the thickness would be 100 nm after drying. The low refractive index coating material A was dried and then cured by irradiation with ultraviolet rays at a light intensity of 300 mJ/cm² with a high-pressure mercury lamp, thus forming a low refractive index layer with a thickness of 100 nm. The refractive index of the low refractive index layer was measured by the above method and found to be 1.37.

As described above, an infrared reflective film (transparent heat-shielding/heat-insulating member) including a protective layer composed of the optical adjustment layer, the medium refractive index layer, the high refractive index layer, and the low refractive index layer was produced. The thickness of the protective layer was 300 nm.

<Formation of Adhesive Layer>

First, a release PET film “NS-38+A” (trade name, thickness: 38 μm) manufactured by Nakamoto Packs Co., Ltd., in which one surface was treated with silicone, was prepared. Moreover, 1.25 parts by mass of an ultraviolet absorber (benzophenone) manufactured by Wako Pure Chemical Industries, Ltd. and 0.27 parts by mass of a crosslinking agent “E-AX” (trade name, solid content: 5% by mass) manufactured by Soken Chemical & Engineering Co., Ltd. were added to 100.00 parts by mass of an acrylic adhesive “SK-Dyne 2094” (trade name, solid content: 25% by mass) manufactured by Soken Chemical & Engineering Co., Ltd., and then mixed by a stirrer to prepare an adhesive coating material.

Next, the adhesive coating material was applied to the silicone-treated surface of the release PET film so that the thickness would be 25 μm after drying. Then, the adhesive coating material was dried to form an adhesive layer. Further, the upper surface of the adhesive layer and the surface of the infrared reflective film on which the infrared reflective layer was not formed were bonded together, thus providing the infrared reflective film (transparent heat-shielding/heat-insulating member) including the protective layer composed of four layers with the adhesive layer.

<Bonding with Glass Substrate>

First, float glass (manufactured by Nippon Sheet Glass Co., Ltd.) with a size of 5 cm×5 cm and a thickness of 3 mm was prepared as a glass substrate. Next, the infrared reflective film that included the protective layer and was provided with the adhesive layer was cut into a size of 3 cm×3 cm, and the release PET film was removed. Then, the infrared reflective film was attached to the float glass with side of the adhesive layer being bonded to the central portion of the float glass.

### Example 2

An optical adjustment coating material B was produced in the same manner as the optical adjustment coating material A of Example 1 except that 0.12 parts by mass (5 parts by mass with respect to the solid content of TYT80-01) of 1-thioglycol having a sulfur-containing group as a corrosion inhibitor for metal was used instead of 2-mercaptobenzothiazole. Then, an infrared reflective film that included a protective layer composed of four layers and was provided with an adhesive layer was produced in the same manner as Example 1 except that the optical adjustment coating material B was used. This infrared reflective film was attached to a glass substrate. The refractive index of the resulting optical adjustment layer was measured by the above method and found to be 1.79.

### Example 3

An optical adjustment coating material C was produced in the same manner as the optical adjustment coating material A of Example 1 except that 0.12 parts by mass (5 parts by mass with respect to the solid content of TYT80-01) of 1-o-tolylbiguanide having a nitrogen-containing group as a corrosion inhibitor for metal was used instead of 2-mercaptobenzothiazole. Then, an infrared reflective film that included a protective layer composed of four layers and was provided with an adhesive layer was produced in the same manner as Example 1 except that the optical adjustment coating material C was used. This infrared reflective film was attached to a glass substrate. The refractive index of the resulting optical adjustment layer was measured by the above method and found to be 1.79.

### Example 4

An optical adjustment coating material D was produced in the same manner as the optical adjustment coating material A of Example 1 except that 0.12 parts by mass (5 parts by mass with respect to the solid content of TYT80-01) of 2-mercaptobenzimidazole having a sulfur-containing group and a nitrogen-containing group as a corrosion inhibitor for metal was used instead of 2-mercaptobenzothiazole. Then, an infrared reflective film that included a protective layer composed of four layers and was provided with an adhesive layer was produced in the same manner as Example 1 except that the optical adjustment coating material D was used. This infrared reflective film was attached to a glass substrate. The refractive index of the resulting optical adjustment layer was measured by the above method and found to be 1.79.

### Example 5

An optical adjustment coating material E was produced in the same manner as the optical adjustment coating material A of Example 1 except that the amount of the titanium oxide hard coating agent “Lioduras TYT80-01” was changed to 9.92 parts by mass, the amount of 2-mercaptobenzothiazole having a sulfur-containing group as a corrosion inhibitor was changed to 0.07 parts by mass (3 parts by mass with respect to the solid content of TYT80-01), and the amount of methyl isobutyl ketone as a diluent solvent was changed to 90.01 parts by mass. Then, an infrared reflective film that included a protective layer composed of four layers and was provided with an adhesive layer was produced in the same manner as Example 1 except that the optical adjustment coating material E was used. This infrared reflective film was attached to a glass substrate. The refractive index of the resulting optical adjustment layer was measured by the above method and found to be 1.80.

### Example 6

An optical adjustment coating material F was produced in the same manner as the optical adjustment coating material A of Example 1 except that the amount of the titanium oxide hard coating agent “Lioduras TYT80-01.” was changed to 9.20 parts by mass, the amount of 2-mercaptobenzothiazole having a sulfur-containing group as a corrosion inhibitor was changed to 0.23 parts by mass (10 parts by mass with respect to the solid content of TYT80-01), and the amount of methyl isobutyl ketone as a diluent solvent was changed to 90.57 parts by mass. Then, an infrared reflective film that included a protective layer composed of four layers and was provided with an adhesive layer was produced in the same manner as Example 1 except that the optical adjustment coating material F was used. This infrared reflective film was attached to a glass substrate. The refractive index of the resulting optical adjustment layer was measured by the above method and found to be 1.78.

### Example 7

An optical adjustment coating material G was produced in the same manner as the optical adjustment coating material A of Example 1 except that the amount of the titanium oxide hard coating agent “Lioduras TYT80-01” was changed to 8.80 parts by mass, the amount of 2-mercaptobenzothiazole having a sulfur-containing group as a corrosion inhibitor was changed to 0.33 parts by mass (15 parts by mass with respect to the solid content of TYT80-01), and the amount of methyl isobutyl ketone as a diluent solvent was changed to 90.87 parts by mass. Then, an infrared reflective film that included a protective layer composed of four layers and was provided with an adhesive layer was produced in the same manner as Example 1 except that the optical adjustment coating material C was used. This infrared reflective film was attached to a glass substrate. The refractive index of the resulting optical adjustment layer was measured by the above method and found to be 1.77.

### Example 8

<Production of Medium Refractive Index Coating Material>

First, 2.80 parts by mass of an IN curable acrylic polymer “SMP-360A” (trade name, solid content concentration: 50% by mass) manufactured by Kyoeisha Chemical Co., Ltd., 0.07 parts by mass (5 parts by mass with respect to the solid content of SMP-360A) of 2-mercaptobenzothiazole having a sulfur-containing group as a corrosion inhibitor, 38.85 parts by mass of methyl ethyl ketone as a diluent solvent, 58.28 parts by mass of cyclohexanone, and 0.03 parts by mass of a photopolymerization initiator “Irgacure 907” (trade name) manufactured by BASF were mixed by a stirrer to produce a medium refractive index coating material B.

Then, an infrared reflective film that included a protective layer composed of four layers and was provided with an adhesive layer was produced in the same manner as Example 6 except that the medium refractive index coating material B was used. This infrared reflective film was attached to a glass substrate. The refractive index of the resulting medium refractive index layer was measured by the above method and found to be 1.50.

### Example 9

<Production of Medium Refractive Index Coating Material>

First, 2.71 parts by mass of pentaerythritol triacrylate “PE-3A” (trade name) manufactured by Kyoeisha Chemical Co., Ltd., 0.14 parts by mass of methacrylate containing a phosphoric acid group “KAYAMER PM-21” (trade name) manufactured by Nippon Kayaku Co., Ltd., 0.09 parts by mass of a photopolymerization initiator “Irgacure 184” (trade name) manufactured by BASF 0.14 parts by mass (5 parts by mass with respect to the total mass of PE-3A and PM-21) of 2-mercaptobenzothiazole having a sulfur-containing group as a corrosion inhibitor, and 97.01 parts by mass of methyl isobutyl ketone as a diluent solvent were mixed by a stirrer to produce a medium refractive index coating material C.

Then, an infrared reflective film that included a protective layer composed of three layers and was provided with an adhesive layer was produced in the same manner as Example 1 except that the medium refractive index coating material C was used, and the thickness of the medium refractive index layer was changed to 150 nm and the thickness of the high refractive index layer was changed to 290 nm without providing an optical adjustment layer. This infrared reflective film was attached to a glass substrate. The refractive index of the resulting medium refractive index layer was measured by the above method and found to be 1.50. The thickness of the resulting protective layer was 540 nm.

### Example 10

<Production of High Refractive Index Coating Material>

First, 19.04 parts by mass of a titanium oxide hard coating agent “Lioduras TYT80-01”, 0.24 parts by mass (5 parts by mass with respect to the solid content of TYT80-01) of 2-mercaptobenzothiazole having a sulfur-containing group as a corrosion inhibitor, and 80.72 parts by mass of methyl isobutyl ketone as a diluent solvent were mixed by a stirrer to produce a high refractive index coating material B.

Then, an infrared reflective film that included a protective layer composed of two layers and was provided with an adhesive layer was produced in the same manner as Example 1 except that the high refractive index coating material B was used, and the thickness of the high refractive index layer was changed to 145 nm and the thickness of the low refractive index layer was changed to 95 nm without providing an optical adjustment layer and a medium refractive index layer. This infrared reflective film was attached to a glass substrate. The refractive index of the resulting high refractive index layer was measured by the above method and found to be 1.79. The thickness of the resulting protective layer was 240 nm.

### Example 11

<Production of Medium Refractive Index Coating Material>

First, 16.54 parts by mass of an ionizing radiation curable acrylic polymer solution “SMP-250A” (trade name, solid content concentration: 50% by mass) manufactured by Kyoeisha Chemical Co., Ltd., 0.48 parts by mass of a methacrylic acid derivative containing a phosphoric acid group “LIGHT ESTER P-2M” (trade name) manufactured by Kyoeisha Chemical Co., Ltd., 0.83 parts by mass (6.97 parts by mass with respect to the total mass of the resin composition) of a fluorine-containing urethane (meth)acrylate monomer “Fomblin MT70” (trade name, solid content concentration: 80% by mass) manufactured by Solvay Specialty Polymers Japan. K.K., 0.1.3 parts by mass (1.36 parts by mass with respect to the total mass of the resin composition) of silicone-modified acrylate “TEGO Rad 2650” manufactured by Evonik Degussa Japan Co., Ltd., 0.48 parts by mass of a photopolymerization initiator “Irgacure 819” (trade name) manufactured by BASE 0.48 parts by mass (5 parts by mass with respect to the total mass of the solid content of SMP-250A, P-2M, the solid content of MT70, and TEGO Rad 2650) of 2-mercaptobenzothiazole having a sulfur-containing group as a corrosion inhibitor, and 81.54 parts by mass of methyl isobutyl ketone as a diluent solvent were mixed by a stirrer to produce a medium refractive index coating material D.

Then, an infrared reflective film that included a protective layer composed of a single layer and was provided with an adhesive layer was produced in the same manner as Example 1 except that the medium refractive index coating material D was used, and the thickness of the medium refractive index layer was changed to 980 nm without providing an optical adjustment layer, a high refractive index layer, and a low refractive index layer. This infrared reflective film was attached to a glass substrate. The refractive index of the resulting medium refractive index layer was measured by the above method and found to be 1.49.

### Example 12

An infrared reflective film that included a protective layer composed of four layers and was provided with an adhesive layer was produced in the same manner as Example 1 except that the thickness of the optical adjustment layer was changed to 40 nm, the thickness of the medium refractive index layer was changed to 80 nm, and the thickness of the high refractive index layer was changed to 270 nm. This infrared reflective film was attached to a glass substrate. The thickness of the resulting protective layer was 490 nm.

### Example 13

An infrared reflective film that included a protective layer composed of four layers and was provided with an adhesive layer was produced in the same manner as Example 1 except that the thickness of the metal layer (Ag layer) of the infrared reflective layer was changed to 7 nm. This infrared reflective film was attached to a glass substrate. The total thickness of the resulting infrared reflective layer (including the first metal suboxide (TiOₓ) layer, the metal (Ag) layer, and the second metal suboxide (TiOₓ) layer) was 11 nm. The ratio of the thickness of the second metal suboxide (TiOₓ) layer to the total thickness was 18.2%.

### Example 14

An infrared reflective film that included a protective layer composed of four layers and was provided with an adhesive layer was produced in the same manner as Example 1 except that the thickness of the metal layer (Ag layer) of the infrared reflective layer was changed to 19 nm. This infrared reflective film was attached to a glass substrate. The total thickness of the resulting infrared reflective layer (including the first metal suboxide (TiOₓ) layer, the metal (Ag) layer, and the second metal suboxide (TiOₓ) layer) was 23 nm. The ratio of the thickness of the second metal suboxide (TiOₓ) layer to the total thickness was 8.7%.

### Example 15

An infrared reflective film that included a protective layer composed of four layers and was provided with an adhesive layer was produced in the same manner as Example 1 except that the thickness of the second metal suboxide (TiOₓ) layer of the infrared reflective layer was changed to 1 nm. This infrared reflective film was attached to a glass substrate. The total thickness of the resulting infrared reflective layer (including the first metal suboxide (TiOₓ) layer, the metal (Ag) layer, and the second metal suboxide (TiOₓ) layer) was 15 nm. The ratio of the thickness of the second metal suboxide (TiOₓ) layer to the total thickness was 6.7%.

### Examples 16

An infrared reflective film that included a protective layer composed of four layers and was provided with an adhesive layer was produced in the same manner as Example 1 except that the thickness of the second metal suboxide (TiOₓ) layer of the infrared reflective layer was changed to 4 nm. This infrared reflective film was attached to a glass substrate. The total thickness of the resulting infrared reflective layer (including the first metal suboxide (TiOₓ) layer, the metal (Ag) layer, and the second metal suboxide (TiOₓ) layer) was 18 nm. The ratio of the thickness of the second metal suboxide (TiOₓ) layer to the total thickness was 22.2%.

### Example 17

<Production of Transparent Base Substrate Provided with Infrared Reflective Layer>

First, the PET film “U483” (thickness: 50 μm), in which both surfaces were subjected to an easy adhesion treatment, was used as a transparent base substrate. Then, a first metal suboxide layer, a metal layer; and a second metal suboxide layer were formed on one surface of the PET an from the PET film side as follows. Using a titanium target, a first metal titanium layer (Ti layer) with a thickness of 2 nm was formed by a sputtering method. In the sputtering method, the sputtering gas was 100% Ar gas. Subsequently, using a silver target, a metal layer (Ag layer) with a thickness of 12 nm was formed on the first metal titanium layer by a sputtering method. In the sputtering method, the sputtering gas was 100% Ar gas. Moreover, using a titanium target, a second metal titanium layer (Ti layer) with a thickness of 2 nm was formed on the metal layer by a sputtering method. In the sputtering method, the sputtering gas was 100% Ar gas. Then, the roll thus obtained was unwound with exposure to the atmosphere so that the titanium layer was slowly oxidized. Thus, a PET film provided with an infrared reflective layer was produced, which had a three-layer structure of first metal suboxide (TiOₓ) layer/metal (Ag) layer/second metal suboxide (TiOₓ) layer on the transparent base substrate. In this case, x of the TiOₓ layer was 1.5.

An infrared reflective film that included a protective layer composed of four layers and was provided with an adhesive layer was produced in the same manner as Example 1 except that the above PET film provided with the infrared reflective layer was used. This infrared reflective film was attached to a glass substrate.

### Example 18

A low refractive index coating material B was produced in the same manner as the low refractive index coating material A of Example 1 except that the amount of pentaerythritol triacrylate “Viscoat #300” manufactured by OSAKA ORGANIC CHEMICAL INDUSTRY LTD. was changed to 1.03 parts by mass, the amount of the fluorine-containing urethane (meth)acrylate monomer “Fomblin MT70” manufactured by Solvay Specialty Polymers Japan K.K. was changed to 0.34 parts by mass (18.13 parts by mass with respect to the total mass of the resin composition), and the amount of methyl isobutyl ketone as a diluent solvent was changed to 15.48 parts by mass. Then, an infrared reflective film that included a protective layer composed of four layers and was provided with an adhesive layer was produced in the same manner as Example 1 except that the low refractive index coating material B was used. This infrared reflective film was attached to a glass substrate. The refractive index of the resulting low refractive index layer was measured by the above method and found to be 1.36.

### Example 19

A low refractive index coating material C was produced in the same manner as the low refractive index coating material A of Example 1 except that the amount of pentaerythritol triacrylate “Viscoat #300” manufactured by OSAKA ORGANIC CHEMICAL INDUSTRY LTD. was changed to 1.15 parts by mass and the amount of silicone-modified acrylate “TECO Rad 2650” manufactured by Evonik Degussa. Japan Co., Ltd. was changed to 0.07 parts by mass (4.66 parts by mass with respect to the total mass of the resin composition). Then, an infrared reflective film that included a protective layer composed of four layers and was provided with an adhesive layer was produced in the same manner as Example 1 except that the low refractive index coating material C was used. This infrared reflective an was attached to a glass substrate. The refractive index of the resulting low refractive index layer was measured by the above method and found to be 1.37.

### Example 20

<Production of Transparent Base Substrate Provided with Infrared Reflective Layer>

First, the PET film “U483” (thickness: 50 μm), in which both surfaces were subjected to an easy adhesion treatment, was used as a transparent base substrate. Then, a first metal oxide layer, a metal layer, and a second metal suboxide layer were formed on one surface of the PET film from the PET film side as follows. Using a titanium oxide target, a first metal oxide layer (TiO₂ layer) with a thickness of 2 nm was formed by a sputtering method. In the sputtering method, the sputtering gas was 100% Ar gas. Subsequently, using a silver target, a metal layer (Ag layer) with a thickness of 12 nm was formed on the first metal oxide layer by a sputtering method. In the sputtering method, the sputtering gas was 100% Ar gas. Moreover, using a titanium target, a second metal suboxide layer (TiOₓ layer) with a thickness of 2 nm was formed on the metal layer by a reactive sputtering method. In the reactive sputtering method, the sputtering gas was a mixed gas of Ar/O₂, and the gas flow volume ratio of Ar:O₂ was 97%:3%. Thus, a PET film provided with an infrared reflective layer was produced, which had a three-layer structure of first metal oxide (TiO₂) layer/metal (Ag) layer/second metal suboxide (TiOₓ) layer on the transparent base substrate. In this case, x of the TiOₓ layer was 1.5.

An infrared reflective film that included a protective layer composed of four layers and was provided with an adhesive layer was produced in the same manner as Example 1 except that the above PET film provided with the infrared reflective layer was used. This infrared reflective film was attached to a glass substrate.

### Example 21

<Production of Transparent Base Substrate Provided with Infrared Reflective Layer>

First, the PET film “U483” (thickness: 50 μm), in which both surfaces were subjected to an easy adhesion treatment, was used as a transparent base substrate. Then, a first metal suboxide layer, a metal layer, and a second metal oxide layer were formed on one surface of the PET film from the PET film side as follows. Using a titanium target, a first metal suboxide layer (TiOₓ layer) with a thickness of 2 nm was formed by a reactive sputtering method. In the reactive sputtering method, the sputtering gas was a mixed gas of Ar/O₂, and the gas flow volume ratio of Ar:O₂ was 97%:3%, Subsequently, using a silver target, a metal layer (Ag layer) with a thickness of 12 nm was formed on the first metal suboxide layer by a sputtering method. In the sputtering method, the sputtering gas was 100% Ar gas. Moreover, using a titanium oxide target, a second metal oxide layer (TiO₂ layer) with a thickness of 2 nm was formed on the metal layer by a sputtering method. In the sputtering method, the sputtering gas was 100% Ar gas. Thus, a PET film provided with an infrared reflective layer was produced, which had a three-layer structure of first metal suboxide MOO layer/metal (Ag) layer/second metal oxide (TiO₂) layer on the transparent base substrate. In this case, x of the TiOₓ layer was 1.5.

An infrared reflective film that included a protective layer composed of four layers and was provided with an adhesive layer was produced in the same manner as Example 1 except that the above PET film provided with the infrared reflective layer was used. This infrared reflective film was attached to a glass substrate.

### Example 22

<Production of Transparent Base Substrate Provided with Infrared Reflective Layer>

First, the PET film “U483” (thickness: 50 μm), in which both surfaces were subjected to an easy adhesion treatment, was used as a transparent base substrate. Then, a first metal oxide layer, a metal layer, and a second metal oxide layer were formed on one surface of the PET film from the PET film side as follows. Using a titanium oxide target, a first metal oxide layer (TiO₂ layer) with a thickness of 2 nm was formed by a sputtering method. In the sputtering method, the sputtering gas was 100% Ar gas. Subsequently, using a silver target, a metal layer (Ag layer) with a thickness of 12 nm was formed on the first metal oxide layer by a sputtering method. In the sputtering method, the sputtering gas was 100% Ar gas. Moreover, using a titanium oxide target, a second metal oxide layer (TiO₂ layer) with a thickness of 2 nm was formed on the metal layer by a sputtering method. In the sputtering method, the sputtering gas was 100% Ar gas. Thus, a PET film provided with an infrared reflective layer was produced, which had a three-layer structure of first metal oxide (TiO₂) layer/metal (Ag) layer/second metal oxide (TiO₂) layer on the transparent base substrate.

An infrared reflective film that included a protective layer composed of four layers and was provided with an adhesive layer was produced in the same manner as Example 1 except that the above PET film provided with the infrared reflective layer was used. This infrared reflective film was attached to a glass substrate.

### Example 23

<Production of Low Refractive Index Coating Material>

First, 7.32 parts by mass of a hollow silica fine particle dispersion “THRULYA 4110” (trade name, solid content concentration: 20.50% by mass) manufactured by JGC Catalysts and Chemicals Ltd., 1.20 parts by mass of pentaerythritol triacrylate “Viscoat #300” (trade name) manufactured by OSAKA ORGANIC CHEMICAL INDUSTRY LTD., 0.30 parts by mass of 1,6-hexanediol diacrylate (trade name) manufactured by Shin Nakamura Chemical Co., Ltd., 0.08 parts by mass of a photopolymerization initiator “Irgacure 907” (trade name) manufactured by BASF, 60.14 parts by mass of isopropyl alcohol as a diluent solvent, 15.52 parts by mass of methyl isobutyl ketone as a diluent solvent, and 15.52 parts by mass of isopropylene glycol were mixed by a stirrer to produce a low refractive index coating material D.

Then, an infrared reflective film that included a protective layer composed of four layers and was provided with an adhesive layer was produced in the same manner as Example 1 except that the low refractive index coating material D was used. This infrared reflective film was attached to a glass substrate. The refractive index of the resulting low refractive index layer was measured by the above method and found to be 1.38.

### Example 24

An infrared reflective film that included a protective layer composed of four layers and was provided with an adhesive layer was produced in the same manner as Example 2 except that the low refractive index coating material D produced in Example 23 was used instead of the low refractive index coating material A. This infrared reflective film was attached to a glass substrate. The refractive index of the resulting low refractive index layer was measured by the above method and found to be 1.38.

### Example 25

An infrared reflective film that included a protective layer composed of three layers and was provided with an adhesive layer was produced in the same manner as Example 9 except that the low refractive index coating material D produced in Example 23 was used instead of the low refractive index coating material A. This infrared reflective film was attached to a glass substrate. The refractive index of the resulting low refractive index layer was measured by the above method and found to be 1.38.

### Example 26

An infrared reflective film that included a protective layer composed of two layers and was provided with an adhesive layer was produced in the same manner as Example 10 except that the low refractive index coating material D produced in Example 23 was used instead of the low refractive index coating material A. This infrared reflective film was attached to a glass substrate. The refractive index of the resulting low refractive index layer was measured by the above method and found to be 1.38.

### Example 27

<Production of Medium Refractive Index Coating Material>

First, 18.14 parts by mass of an ionizing radiation curable acrylic polymer solution “SMP-250A” (trade name, solid content concentration: 50% by mass) manufactured by Kyoeisha Chemical Co., Ltd., 0.48 parts by mass of a methacrylic acid derivative containing a phosphoric acid group “LIGHT ESTER P-2M” (trade name) manufactured by Kyoeisha Chemical Co., Ltd., 0.48 parts by mass of a photopolymerizadon initiator “Irgacure 819” (trade name) manufactured by BASF, 0.48 parts by mass (5 parts by mass with respect to the total mass of the solid content of SMP-250A and P-2M) of 2-mercaptobenzothiazole having a sulfur-containing group as a corrosion inhibitor, and 80.91 parts by mass of methyl isobutyl ketone as a diluent solvent were mixed by a stirrer to produce a medium refractive index coating material E.

Then, an infrared reflective film that included a protective layer composed of a single layer and was provided with an adhesive layer was produced in the same manner as Example 1 except that the medium refractive index coating material E was used, and the thickness of the medium refractive index layer was changed to 980 nm without providing an optical adjustment layer, a high refractive index layer, and a low refractive index layer. This infrared reflective film was attached to a glass substrate. The refractive index of the resulting medium refractive index layer was measured by the above method and found to be 1.50.

### Example 28

An infrared reflective film that included a protective layer composed of four layers and was provided with an adhesive layer was produced in the same manner as Example 1 except that a hollow silica-containing low refractive index coating material “ELCOM P-5062” (trade name, solid content concentration: 3% by mass, refractive index: 1.38 (nominal value])) was used as a low refractive index coating material E instead of the low refractive index coating material A. This infrared reflective film was attached to a glass substrate. The refractive index of the resulting low refractive index layer was measured by the above method and found to be 1.38.

### Comparative Example 1

An optical adjustment coating material H was produced in the same manner as the optical adjustment coating material A of Example 1 except that the amount of the titanium oxide hard coating agent “Lioduras TYT80-01” was changed to 10.00 parts by mass, the amount of methyl isobutyl ketone as a diluent solvent was changed to 90.00 parts by mass, and 2-mercaptobenzothiazole having a sulfur-containing group as a corrosion inhibitor was not added.

Then, an infrared reflective film that included a protective layer composed of four layers and was provided with an adhesive layer was produced in the same manner as Example 23 except that the optical adjustment coating material H was used. This infrared reflective film was attached to a glass substrate. The refractive index of the resulting optical adjustment layer was measured by the above method and found to be 1.80.

### Comparative Example 2

<Production of Transparent Base Substrate Provided with Infrared Reflective Layer>

First, the PET film “U483” (thickness: 50 μm), in which both surfaces were subjected to an easy adhesion treatment, was used as a transparent base substrate. Then, a first metal oxide layer, a metal layer, and a second metal oxide layer were formed on one surface of the PET film from the PET film side as follows. Using a target having a metal composition of tin/zinc=90% by mass/10% by mass, a first metal oxide layer (ZTO layer) with a thickness of 10 nm was formed by a reactive sputtering method. In the reactive sputtering method, the sputtering gas was a mixed gas of Ar/O₂, and the gas flow volume ratio of Ar:O₂ was 97%:3%. Subsequently, using a silver target, a metal layer (Ag layer) with a thickness of 12 nm was formed on the first metal oxide layer by a sputtering method. In the sputtering method, the sputtering gas was 100% Ar gas. Moreover, using a target having a metal composition of tin/zinc=90% by mass/10% by mass, a second metal oxide layer (ZTO layer) with a thickness of 10 nm was formed on the metal layer by a reactive sputtering method. In the reactive sputtering method, the sputtering gas was a mixed gas of Ar/O₂, and the gas flow volume ratio of Ar:O₂ was 97%:3%, Thus, a PET film provided with an infrared reflective layer was produced, which had a three-layer structure of first metal oxide (ZTO) layer/metal (Ag) layer/second metal oxide (ZTO) layer on the transparent base substrate.

The total thickness of the resulting infrared reflective layer (including the first metal oxide (ZTO) layer, the metal (Ag) layer, and the second metal oxide (ATO) layer) was 32 nm. The ratio of the thickness of the second metal oxide (ZTO) layer to the total thickness was 31.3%.

<Formation of Low Refractive Index Layer>

The low refractive index coating material D produced in Example 23 was applied to the surface of the infrared reflective layer with a micro-gravure coater (manufactured by YASUI SEMI CO., LTD.) so that the thickness would be 65 nm after drying. The low refractive index coating material D was dried and then cured by irradiation with ultraviolet rays at a light intensity of 300 mJ/cm² with a high-pressure mercury lamp, thus forming a low refractive index layer with a thickness of 65 nm. The refractive index of the low refractive index layer was measured by the above method and found to be 1.38.

As described above, an infrared reflective film (transparent heat-shielding/heat-insulating member) including a protective layer composed of a single layer was produced. An infrared reflective film that included a protective layer composed of a single layer and was provided with an adhesive layer was produced in the same manner as Example 1 except that the above PET film provided with the infrared reflective layer including the protective layer was used. This infrared reflective film was attached to a glass substrate.

### Comparative Example 3

An infrared reflective film that included a protective layer composed of four layers and was provided with an adhesive layer was produced in the same manner as Example 21 except that the thickness of the second metal oxide layer (TiO₂ layer) of the infrared reflective layer was changed to 7 nm. This infrared reflective film was attached to a glass substrate.

The total thickness of the resulting infrared reflective layer (including the first metal suboxide (TiOₓ) layer, the metal (Ag) layer, and the second metal oxide (TiO₂) layer) was 21 nm. The ratio of the thickness of the second metal oxide (TiO₂) layer to the total thickness was 33.3%.

<Evaluation of Transparent Heat-Shielding/Heat-Insulating Member>

The following measurements of visible light transmittance, visible light reflectance, solar absorptance, shading coefficient, and thermal transmittance were performed on each of the infrared reflective films (transparent heat-shielding/heat-insulating members) attached to the glass substrates in Examples 1 to 28 and Comparative Examples 1 to 3. Moreover, the fingerprint wiping properties, salt water resistance, scratch resistance, and appearance of the infrared reflective films were evaluated.

[Visible Light Transmittance]

Using an ultraviolet-visible near-infrared spectrophotometer “Ubest V-570” (trade name) manufactured by JASCO Corporation, a spectral transmittance was measured in the wavelength range of 380 to 780 nm by setting the glass substrate as the light incident side, and a visible light transmittance was calculated based on JIS A5759-2008.

[Visible Light Reflectance]

Using the Ultraviolet-visible near-infrared spectrophotometer “Ubest V-570”, a spectral reflectance was measured in the wavelength range of 380 to 780 nm by setting the glass substrate as the light incident side, and a visible light reflectance was calculated in accordance with JIS R3106-1998.

[Solar Absorptance]

Using the ultraviolet-visible near-infrared spectrophotometer “Ubest V-570”, a spectral transmittance and a spectral reflectance were measured in the wavelength range of 300 to 2500 nm by setting the glass substrate as the light incident side, a solar transmittance and a solar reflectance were determined in accordance with JIS A5759-2008, and a solar absorptance was calculated from the values of the solar transmittance and the solar reflectance.

[Shading Coefficient]

Using the ultraviolet-visible near-infrared spectrophotometer “Ubest V570”, a spectral transmittance and a spectral reflectance were measured in the wavelength range of 300 to 2500 nm by setting the glass substrate as the light incident side, a solar transmittance and a solar reflectance were determined in accordance with JIS A5759, a normal emissivity was determined in accordance with JIS R3106-2008, and a shading coefficient was calculated from the values of the solar transmittance, the solar reflectance, and the normal emissivity

[Thermal Transmittance]

Using an infrared spectrophotometer “IR Prestige 21” (trade name) manufactured by SHIMADZU CORPORATION, which was equipped with an attachment for measuring specular reflection, a spectral specular reflectance was measured in the wavelength range of 5.5 to 25.2 μm on both the protective layer side and the glass substrate side of the infrared reflective film, a normal emissivity was determined on both the protective layer side and the glass substrate side of the infrared reflective film in accordance with JIS R3106-2008, and a thermal transmittance was determined based on these results in accordance with JIS A5759-2008.

[Fingerprint Wiping Properties]

First, the fingerprint of the index finger was put on the surface of the protective layer of the transparent heat-shielding/heat-insulating member. Subsequently, the protective layer was wiped with a cleaning cloth “Toraysee (registered trademark)” manufactured by Toray Industries, Inc. in a back and forth motion repeatedly 5 times to remove the fingerprint. Then, the traces of wiping on the surface of the protective layer were visually observed, and the fingerprint wiping properties of the protective layer were evaluated in the following three stages.

Excellent: There was almost no trace of the fingerprint.

Good: Some traces of the fingerprint were found.

Bad: Distinct traces of the fingerprint were found.

[Salt Water Resistance]

First, using the ultraviolet-visible near-infrared spectrophotometer “Ubest V-570”, a spectral transmittance of the infrared reflective film attached to the glass substrate was measured in the wavelength range of 300 to 1500 nm, and a transmittance T_{B} (% unit) for light with a wavelength of 1100 nm was determined. Then, a salt water resistance test was performed in the following manner. The infrared reflective film attached to the glass substrate was immersed in a sodium chloride aqueous solution with a concentration of 5% by mass. The infrared reflective film in this state was placed in a constant temperature and humidity bath at 50° C. and stored for 10 days. After the completion of the salt water resistance test, the infrared reflective film attached to the glass substrate was washed with pure water and dried in the air. Subsequently, a transmittance T_{A} (% unit) of the infrared reflective film attached to the glass substrate for light with a wavelength of 1100 nm was measured in the same manner as described above. Based on the measurement results, a difference between the transmittances for light with a wavelength of 1100 nm before and after the salt water resistance test, i.e., the point value of T_{A}-T_{B} was calculated.

[Scratch Resistance]

First, a white flannel cloth was arranged on the protective layer of the transparent heat-shielding/heat-insulating member and moved back and forth 1000 times under a load of 1000 g/cm². Then, the state of the surface of the protective layer was visually observed in a certain field of view and the scratch properties of the protective layer were evaluated in the following three stages.

Excellent: There was no scratch at all.

Good: Several scratches (5 or less) were found.

Bad: Many scratches (6 or more) were found.

[Appearance]

First, the surface of the transparent heat-shielding/heat-insulating member on the protective layer side was visually observed under a three band fluorescent lamp. Then, the appearance (i.e., iris patterns and a change in reflected color depending on the viewing angle) of the transparent heat-shielding/heat-insulating member was evaluated in the following three stages.

Excellent: There were almost no iris pattern and change in reflected color depending on the viewing angle.

Good: Some iris patterns and/or changes in reflected color depending on the viewing angle were found.

Bad: Obvious iris patterns and/or changes in reflected color depending on the viewing angle were found.

Tables 1 to 8 show the evaluation results along with the layer structures of the infrared reflective films (transparent heat-shielding/heat-insulating members).

TABLE 1

| | | | Example 1 | Example 2 |
|---|---|---|---|---|
| Layer | Low refractive index layer | | low refractive index coating material A | low refractive index coating material A |
| configuration | | | thickness: 100 nm | thickness: 100 nm |
| | | | refractive index: 1.37 | refractive index: 1.37 |
| | High refractive index layer | | high refractive index coating material A | high refractive index coating material A |
| | | | thickness: 90 nm | thickness: 90 nm |
| | | | refractive index: 1.80 | refractive index: 1.80 |
| | Medium refractive index layer | | medium refractive index coating | medium refractive index coating |
| | | | material A | material A |
| | | | thickness: 60 nm | thickness: 60 nm |
| | | | refractive index: 1.50 | refractive index: 1.50 |
| | Optical adjustment layer | | optical adjustment coating material A | optical adjustment coating material B |
| | | | thickness: 50 nm | thickness: 50 nm |
| | | | refractive index: 1.79 | refractive index: 1.79 |
| | Corrosion | Type | 2-mercaptobenzothiazole | 1-thioglycol |
| | inhibitor | Amount added (parts by mass: solid | 5/optical adjustment layer | 5/optical adjustment layer |
| | | content)/layer added | | |
| | Fluorine-containing (meth)acrylate | | 6.98/low refractive index layer | 6.93/low refractive index layer |
| | Amount added (parts by mass: resin content)/ | | | |
| | layer added | | | |
| | Silicone-modified acrylate | | 1.38/low refractive index layer | 1.33/low refractive index layer |
| | Amount added (parts by mass: resin content)/ | | | |
| | layer added | | | |
| | Infrared | Second metal suboxide layer | TiOₓ layer: 2 nm | TiOₓ layer: 2 nm |
| | reflective | Metal layer | Ag layer: 12 nm | Ag layer: 12 nm |
| | layer | First metal suboxide layer | TiOₓ layer: 2 nm | TiOₓ layer: 2 nm |
| | | Total thickness (nm) | 16 | 16 |
| | | Ratio of thickness of second metal | 12.5 | 12.5 |
| | | suboxide layer (%) | | |

| | | |
|---|---|---|
| Thickness of protective layer (nm) | 300 | 300 |

| Visible light transmittance (%) | | | 72.4 | 72.5 |
|---|---|---|---|---|
| Visible light reflectance (%) | | | 20.5 | 20.4 |
| Solar absorptance (%) | | | 16.3 | 16.2 |
| Shading coefficient | | | 0.59 | 0.59 |
| Thermal transmittance (W/(m² · K)) | | | 3.7 | 3.7 |
| Fingerprint wiping properties | | | excellent | excellent |
| Salt water resistance (T_{A} − T_{B}) | | | 1.2 | 1.1 |
| Scratch resistance | | | excellent | excellent |
| Appearance | | | excellent | excellent |
| | | | Example 3 | Example 4 |
| | Layer | Low refractive index layer | low refractive index coating material A | low refractive index coating material A |
| | configuration | | thickness: 100 nm | thickness: 100 nm |
| | | | refractive index: 1.37 | refractive index: 1.37 |
| | | High refractive index layer | high refractive index coating material A | high refractive index coating material A |
| | | | thickness: 90 nm | thickness: 90 nm |
| | | | refractive index: 1.80 | refractive index: 1.80 |
| | | Medium refractive index layer | medium refractive index coating | medium refractive index coating |
| | | | material A | material A |
| | | | thickness: 60 nm | thickness: 60 nm |
| | | | refractive index: 1.50 | refractive index: 1.50 |
| | | Optical adjustment layer | optical adjustment coating material C | optical adjustment coating material D |
| | | | thickness: 50 nm | thickness: 50 nm |
| | | | refractive index: 1.79 | refractive index: 1.79 |

| Corrosion | Type | 1-o-tolylbiguanide | 2-mercaptobenzothiazole |
|---|---|---|---|
| inhibitor | Amount added (parts by mass: solid | 5/optical adjustment layer | 5/optical adjustment layer |
| | content)/layer added | | |
| Fluorine-containing (meth)acrylate | | 6.98/low refractive index layer | 6.93/low refractive index layer |
| Amount added (parts by mass: resin content)/ | | | |
| layer added | | | |
| Silicone-modified acrylate | | 1.33/low refractive index layer | 1.33/low refractive index layer |
| Amount added (parts by mass: resin content)/ | | | |
| layer added | | | |
| Infrared | Second metal suboxide layer | TiOₓ layer: 2 nm | TiOₓ layer: 2 nm |
| reflective | Metal layer | Ag layer: 12 nm | Ag layer: 12 nm |
| layer | First metal suboxide layer | TiOₓ layer: 2 nm | TiOₓ layer: 2 nm |
| | Total thickness (nm) | 16 | 16 |
| | Ratio of thickness of second metal | 12.5 | 12.5 |
| | suboxide layer (%) | | |

| | | |
|---|---|---|
| Thickness of protective layer (nm) | 300 | 300 |

| | | |
|---|---|---|
| Visible light transmittance (%) | 72.7 | 72.5 |
| Visible light reflectance (%) | 20.4 | 20.4 |
| Solar absorptance (%) | 16.1 | 16.2 |
| Shading coefficient | 0.60 | 0.59 |
| Thermal transmittance (W/(m² · K)) | 3.7 | 3.7 |
| Fingerprint wiping properties | excellent | excellent |
| Salt water resistance (T_{A} − T_{B}) | 2.0 | 1.3 |
| Scratch resistance | excellent | excellent |
| Appearance | excellent | excellent |

TABLE 2

| | | | Example 5 | Example 6 |
|---|---|---|---|---|
| Layer | Low refractive index layer | | low refractive index coating material A | low refractive index coating material A |
| configuration | | | thickness: 100 nm | thickness: 100 nm |
| | | | refractive index: 1.37 | refractive index: 1.37 |
| | High refractive index layer | | high refractive index coating material A | high refractive index coating material A |
| | | | thickness: 90 nm | thickness: 90 nm |
| | | | refractive index: 1.80 | refractive index: 1.80 |
| | Medium refractive index layer | | medium refractive index coating | medium refractive index coating |
| | | | material A | material A |
| | | | thickness: 60 nm | thickness: 60 nm |
| | | | refractive index: 1.50 | refractive index: 1.50 |
| | Optical adjustment layer | | optical adjustment coating material E | optical adjustment coating material F |
| | | | thickness: 50 nm | thickness: 50 nm |
| | | | refractive index: 1.80 | refractive index: 1.78 |
| | Corrosion | Type | 2-mercaptobenzothiazole | 2-mercaptebenzothiazole |
| | inhibitor | Amount added (parts by mass: solid | 3/optical adjustment layer | 10/optical adjustment layer |
| | | content)/layer added | | |
| | Fluorine-containing (meth)acrylate | | 6.93/low refractive index layer | 6.98/low refractive index layer |
| | Amount added (parts by mass: resin content)/ | | | |
| | layer added | | | |
| | Silicone-modified acrylate | | 1.33/low refractive index layer | 1.33/low refractive index layer |
| | Amount added (parts by mass: resin content)/ | | | |
| | layer added | | | |
| | Infrared | Second metal suboxide layer | TiOₓ layer: 2 nm | TiOₓ layer: 2 nm |
| | reflective | Metal layer | Ag layer: 12 nm | Ag layer: 12 nm |
| | layer | First metal suboxide layer | TiOₓ layer: 2 nm | TiOₓ layer: 2 nm |
| | | Total thickness (nm) | 16 | 16 |
| | | Ratio of thickness of second metal | 12.5 | 12.5 |
| | | suboxide layer (%) | | |

| | | |
|---|---|---|
| Thickness of protective layer (nm) | 300 | 300 |

| Visible light transmittance (%) | | | 72.5 | 72.4 |
|---|---|---|---|---|
| Visible light reflectance (%) | | | 20.6 | 20.1 |
| Solar absorptance (%) | | | 16.1 | 16.7 |
| Shading coefficient | | | 0.53 | 0.59 |
| Thermal transmittance (W/(m² · K)) | | | 3.7 | 3.7 |
| Fingerprint wiping properties | | | excellent | excellent |
| Salt water resistance (T_{A} − T_{B}) | | | 3.8 | 0.5 |
| Scratch resistance | | | excellent | excellent |
| Appearance | | | excellent | excellent |
| | | | Example 7 | Example 8 |
| | Layer | Low refractive index layer | low refractive index coating material A | low refractive index coating material A |
| | configuration | | thickness: 100 nm | thickness: 100 nm |
| | | | refractive index: 1.37 | refractive index: 1.37 |
| | | High refractive index layer | high refractive index coating material A | high refractive index coating material A |
| | | | thickness: 90 nm | thickness: 90 nm |
| | | | refractive index: 1.80 | refractive index: 1.80 |
| | | Medium refractive index layer | medium refractive index coating | medium refractive index coating |
| | | | material A | material B |
| | | | thickness: 60 nm | thickness: 60 nm |
| | | | refractive index: 1.50 | refractive index: 1.50 |
| | | Optical adjustment layer | optical adjustment coating material G | optical adjustment coating material F |
| | | | thickness: 50 nm | thickness: 50 nm |
| | | | refractive index: 1.77 | refractive index: 1.78 |

| Corrosion | Type | 2-mercaptebenzothiazole | 2-mercaptebenzothiazole |
|---|---|---|---|
| inhibitor | Amount added (parts by mass: solid | 15/optical adjustment layer | 5/medium refractive index layer |
| | content)/layer added | | 10/optical adjustment layer |
| Fluorine-containing (meth)acrylate | | 6.93/low refractive index layer | 6.93/low refractive index layer |
| Amount added (parts by mass: resin content)/ | | | |
| layer added | | | |
| Silicone-modified acrylate | | 1.33/low refractive index layer | 1.33/low refractive index layer |
| Amount added (parts by mass: resin content)/ | | | |
| layer added | | | |
| Infrared | Second metal suboxide layer | TiOₓ layer: 2 nm | TiOₓ layer: 2 nm |
| reflective | Metal layer | Ag layer: 12 nm | Ag layer: 12 nm |
| layer | First metal suboxide layer | TiOₓ layer: 2 nm | TiOₓ layer: 2 nm |
| | Total thickness (nm) | 16 | 16 |
| | Ratio of thickness of second metal | 12.5 | 12.5 |
| | suboxide layer (%) | | |

| | | |
|---|---|---|
| Thickness of protective layer (nm) | 300 | 300 |

| | | |
|---|---|---|
| Visible light transmittance (%) | 72.6 | 72.8 |
| Visible light reflectance (%) | 20.5 | 20.4 |
| Solar absorptance (%) | 16.9 | 17.0 |
| Shading coefficient | 0.59 | 0.60 |
| Thermal transmittance (W/(m² · K)) | 3.7 | 3.7 |
| Fingerprint wiping properties | excellent | excellent |
| Salt water resistance (T_{A} − T_{B}) | 0 | 0 |
| Scratch resistance | excellent | excellent |
| Appearance | excellent | excellent |

TABLE 3

| | | | Example 9 | Example 10 |
|---|---|---|---|---|
| Layer | Low refractive index layer | | low refractive index coating material A | low refractive index coating material A |
| configuration | | | thickness: 100 nm | thickness: 95 nm |
| | | | refractive index: 1.37 | refractive index: 1.37 |
| | High refractive index layer | | high refractive index coating material A | high refractive index coating material B |
| | | | thickness: 290 nm | thickness: 145 nm |
| | | | refractive index: 1.80 | refractive index: 1.79 |
| | Medium refractive index layer | | medium refractive index coating | — |
| | | | material C | |
| | | | thickness: 150 nm | |
| | | | refractive index: 1.50 | |
| | Optical adjustment layer | | — | — |
| | Corrosion | Type | 2-mercaptobenzothiazole | 2-mercaptobenzothiazole |
| | inhibitor | Amount added (parts by mass: solid | 5/medium refractive index layer | 5/high refractive index layer |
| | | content)/layer added | | |
| | Fluorine-containing (meth)acrylate | | 6.98/low refractive index layer | 6.93/low refractive index layer |
| | Amount added (parts by mass: resin content)/ | | | |
| | layer added | | | |
| | Silicone-modified acrylate | | 1.88/low refractive index layer | 1.33/low refractive index layer |
| | Amount added (parts by mass: resin content)/ | | | |
| | layer added | | | |
| | Infrared | Second metal suboxide layer | TiOₓ layer: 2 nm | TiOₓ layer: 2 nm |
| | reflective | Metal layer | Ag layer: 12 nm | Ag layer: 12 nm |
| | layer | First metal suboxide layer | TiOₓ layer: 2 nm | TiOₓ layer: 2 nm |
| | | Total thickness (nm) | 16 | 16 |
| | | Ratio of thickness of second metal | 12.5 | 12.5 |
| | | suboxide layer (%) | | |

| | | |
|---|---|---|
| Thickness of protective layer (nm) | 540 | 240 |

| | | |
|---|---|---|
| Visible light transmittance (%) | 72.5 | 65.7 |
| Visible light reflectance (%) | 21.8 | 29.2 |
| Solar absorptance (%) | 15.6 | 15.0 |
| Shading coefficient | 0.59 | 0.57 |
| Thermal transmittance (W/(m² · K)) | 3.7 | 8.7 |
| Fingerprint wiping properties | excellent | excellent |
| Salt water resistance (T_{A} − T_{B}) | 1.0 | 8.8 |
| Scratch resistance | excellent | excellent |
| Appearance | excellent | excellent |

| | | Example 11 | Example 12 |
|---|---|---|---|
| Layer | Low refractive index layer | — | low refractive index coating material A |
| configuration | | | thickness: 100 nm |
| | | | refractive index: 1.37 |
| | High refractive index layer | — | high refractive index coating material A |
| | | | thickness: 270 nm |
| | | | refractive index: 1.80 |
| | Medium refractive index layer | medium refractive index coating | medium refractive index coating |
| | | material D | material A |
| | | thickness: 980 nm | thickness: 80 nm |
| | | refractive index: 1.49 | refractive index: 1.50 |
| | Optical adjustment layer | — | optical adjustment coating material A |
| | | | thickness: 40 nm |
| | | | refractive index: 1.79 |

| Corrosion | Type | 2-mercaptobenzothiazole | 2-mercaptobenzothiazole |
|---|---|---|---|
| inhibitor | Amount added (parts by mass: solid | 5/medium refractive index layer | 5/optical adjustment layer |
| | content)/layer added | | |
| Fluorine-containing (meth)acrylate | | 6.97/medium refractive index layer | 6.93/low refractive index layer |
| Amount added (parts by mass: resin content)/ | | | |
| layer added | | | |
| Silicone-modified acrylate | | 1.36/low refractive index layer | 1.33/low refractive index layer |
| Amount added (parts by mass: resin content)/ | | | |
| layer added | | | |
| Infrared | Second metal suboxide layer | TiOₓ layer: 2 nm | TiOₓ layer: 2 nm |
| reflective | Metal layer | Ag layer: 12 nm | Ag layer: 12 nm |
| layer | First metal suboxide layer | TiOₓ layer: 2 nm | TiOₓ layer: 2 nm |
| | Total thickness (nm) | 16 | 16 |
| | Ratio of thickness of second metal | 12.5 | 12.5 |
| | suboxide layer (%) | | |

| | | |
|---|---|---|
| Thickness of protective layer (nm) | 980 | 490 |

| | | |
|---|---|---|
| Visible light transmittance (%) | 64.2 | 75.8 |
| Visible light reflectance (%) | 30.0 | 19.2 |
| Solar absorptance (%) | 15.5 | 15.4 |
| Shading coefficient | 0.56 | 0.62 |
| Thermal transmittance (W/(m² · K)) | 4.2 | 3.7 |
| Fingerprint wiping properties | excellent | excellent |
| Salt water resistance (T_{A} − T_{B}) | 0 | 1.2 |
| Scratch resistance | excellent | excellent |
| Appearance | good | excellent |

TABLE 4

| | | | Example 13 | Example 14 |
|---|---|---|---|---|
| Layer | Low refractive index layer | | low refractive index coating material A | low refractive index coating material A |
| configuration | | | thickness: 100 nm | thickness: 100 nm |
| | | | refractive index: 1.37 | refractive index: 1.37 |
| | High refractive index layer | | high refractive index coating material A | high refractive index coating material A |
| | | | thickness: 90 nm | thickness: 90 nm |
| | | | refractive index: 1.80 | refractive index: 1.80 |
| | Medium refractive index layer | | medium refractive index coating | medium refractive index coating |
| | | | material A | material A |
| | | | thickness: 60 nm | thickness: 60 nm |
| | | | refractive index: 1.50 | refractive index: 1.50 |
| | Optical adjustment layer | | optical adjustment coating material A | optical adjustment coating material A |
| | | | thickness: 50 nm | thickness: 50 nm |
| | | | refractive index: 1.79 | refractive index: 1.79 |
| | Corrosion | Type | 2-mercaptobenzothiazole | 2-mercaptobenzothiazole |
| | inhibitor | Amount added (parts by mass: solid | 5/optical adjustment layer | 5/optical adjustment layer |
| | | content)/layer added | | |
| | Fluorine-containing (meth)acrylate | | 6.93/low refractive index layer | 6.93/low refractive index layer |
| | Amount added (parts by mass: resin content)/ | | | |
| | layer added | | | |
| | Silicone-modified acrylate | | 1.33/low refractive index layer | 1.33/low refractive index layer |
| | Amount added (parts by mass: resin content)/ | | | |
| | layer added | | | |
| | Infrared | Second metal suboxide layer | TiOₓ layer: 2 nm | TiOₓ layer: 2 nm |
| | reflective | Metal layer | Ag layer: 7 nm | Ag layer: 19 nm |
| | layer | First metal suboxide layer | TiOₓ layer: 2 nm | TiOₓ layer: 2 nm |
| | | Total thickness (nm) | 11 | 23 |
| | | Ratio of thickness of second metal | 18.2 | 8.7 |
| | | suboxide layer (%) | | |

| | | |
|---|---|---|
| Thickness of protective layer (nm) | 300 | 300 |

| Visible light transmittance (%) | | | 76.5 | 54.1 |
|---|---|---|---|---|
| Visible light reflectance (%) | | | 16.5 | 86.2 |
| Solar absorptance (%) | | | 16.0 | 18.1 |
| Shading coefficient | | | 0.65 | 0.47 |
| Thermal transmittance (W/(m² · K)) | | | 3.9 | 3.6 |
| Fingerprint wiping properties | | | excellent | excellent |
| Salt water resistance (T_{A} − T_{B}) | | | 1.8 | 1.2 |
| Scratch resistance | | | excellent | excellent |
| Appearance | | | excellent | excellent |
| | | | Example 15 | Example 16 |
| | Layer | Low refractive index layer | low refractive index coating material A | low refractive index coating material B |
| | configuration | | thickness: 100 nm | thickness: 100 nm |
| | | | refractive index: 1.37 | refractive index: 1.87 |
| | | High refractive index layer | high refractive index coating material A | high refractive index coating material A |
| | | | thickness: 90 nm | thickness: 90 nm |
| | | | refractive index: 1.80 | refractive index: 1.80 |
| | | Medium refractive index layer | medium refractive index coating | medium refractive index coating |
| | | | material A | material A |
| | | | thickness: 60 nm | thickness: 60 nm |
| | | | refractive index: 1.50 | refractive index: 1.50 |
| | | Optical adjustment layer | optical adjustment coating material A | optical adjustment coating material A |
| | | | thickness: 50 nm | thickness: 50 nm |
| | | | refractive index: 1.79 | refractive index: 1.79 |

| Corrosion | Type | 2-mercaptobenzothiazole | 2-mercaptobenzothiazole |
|---|---|---|---|
| inhibitor | Amount added (parts by mass: solid | 5/optical adjustment layer | 5/optical adjustment layer |
| | content)/layer added | | |
| Fluorine-containing (meth)acrylate | | 6.93/low refractive index layer | 6.93/low refractive index layer |
| Amount added (parts by mass: resin content)/ | | | |
| layer added | | | |
| Silicone-modified acrylate | | 1.33/low refractive index layer | 1.33/low refractive index layer |
| Amount added (parts by mass: resin content)/ | | | |
| layer added | | | |
| Infrared | Second metal suboxide layer | TiOₓ layer: 1 nm | TiOₓ layer: 4 nm |
| reflective | Metal layer | Ag layer: 12 nm | Ag layer: 12 nm |
| layer | First metal suboxide layer | TiOₓ layer: 2 nm | TiOₓ layer: 2 nm |
| | Total thickness (nm) | 15 | 18 |
| | Ratio of thickness of second metal | 6.7 | 22.2 |
| | suboxide layer (%) | | |

| | | |
|---|---|---|
| Thickness of protective layer (nm) | 300 | 300 |

| | | |
|---|---|---|
| Visible light transmittance (%) | 75.9 | 73.1 |
| Visible light reflectance (%) | 19.6 | 20.6 |
| Solar absorptance (%) | 15.8 | 17.5 |
| Shading coefficient | 0.61 | 0.59 |
| Thermal transmittance (W/(m² · K)) | 3.7 | 8.7 |
| Fingerprint wiping properties | excellent | excellent |
| Salt water resistance (T_{A} − T_{B}) | 2.1 | 0.8 |
| Scratch resistance | excellent | excellent |
| Appearance | excellent | excellent |

TABLE 5

| | | | Example 17 | Example 18 |
|---|---|---|---|---|
| Layer | Low refractive index layer | | low refractive index coating material C | low refractive index coating material A |
| configuration | | | thickness: 100 nm | thickness: 100 nm |
| | | | refractive index: 1.37 | refractive index: 1.36 |
| | High refractive index layer | | high refractive index coating material A | high refractive index coating material A |
| | | | thickness: 90 nm | thickness: 90 nm |
| | | | refractive index: 1.80 | refractive index: 1.80 |
| | Medium refractive index layer | | medium refractive index coating | medium refractive index coating |
| | | | material A | material A |
| | | | thickness: 60 nm | thickness: 60 nm |
| | | | refractive index: 1.50 | refractive index: 1.50 |
| | Optical adjustment layer | | optical adjustment coating material A | optical adjustment coating material A |
| | | | thickness: 50 nm | thickness: 50 nm |
| | | | refractive index: 1.79 | refractive index: 1.79 |
| | Corrosion | Type | 2-mercaptobenzothiazole | 2-mercaptobenzothiazole |
| | inhibitor | Amount added (parts by mass: solid | 5/optical adjustment layer | 5/optical adjustment layer |
| | | content)/layer added | | |
| | Fluorine-containing (meth)acrylate | | 6.93/low refractive index layer | 18.13/low refractive index layer |
| | Amount added (parts by mass: resin content)/ | | | |
| | layer added | | | |
| | Silicone-modified acrylate | | 1.33/low refractive index layer | 1.33/low refractive index layer |
| | Amount added (parts by mass: resin content)/ | | | |
| | layer added | | | |
| | Infrared | Second metal suboxide layer | TiOₓ layer: 2 nm | TiOₓ layer: 2 nm |
| | reflective | Metal layer | Ag layer: 12 nm | Ag layer: 12 nm |
| | layer | First metal (suboxide) oxide layer | TiOₓ layer: 2 nm | TiOₓ layer: 2 nm |
| | | Total thickness (nm) | 16 | 16 |
| | | Ratio of thickness of second metal | 12.5 | 12.5 |
| | | suboxide layer (%) | | |

| | | |
|---|---|---|
| Thickness of protective layer (nm) | 300 | 300 |

| Visible light transmittance (%) | | | 72.6 | 72.8 |
|---|---|---|---|---|
| Visible light reflectance (%) | | | 20.4 | 20.1 |
| Solar absorptance (%) | | | 16.1 | 15.9 |
| Shading coefficient | | | 0.59 | 0.60 |
| Thermal transmittance (W/(m² · K)) | | | 3.7 | 3.7 |
| Fingerprint wiping properties | | | excellent | excellent |
| Salt water resistance (T_{A} − T_{B}) | | | 0.6 | 1.4 |
| Scratch resistance | | | excellent | good |
| Appearance | | | excellent | excellent |
| | | | Example 19 | Example 20 |
| | Layer | Low refractive index layer | low refractive index coating material A | low refractive index coating material A |
| | configuration | | thickness: 100 nm | thickness: 100 nm |
| | | | refractive index: 1.37 | refractive index: 1.37 |
| | | High refractive index layer | high refractive index coating material A | high refractive index coating material A |
| | | | thickness: 90 nm | thickness: 90 nm |
| | | | refractive index: 1.80 | refractive index: 1.80 |
| | | Medium refractive index layer | medium refractive index coating | medium refractive index coating |
| | | | material A | material A |
| | | | thickness: 60 nm | thickness: 60 nm |
| | | | refractive index: 1.50 | refractive index: 1.50 |
| | | Optical adjustment layer | optical adjustment coating material A | optical adjustment coating material A |
| | | | thickness: 50 nm | thickness: 50 nm |
| | | | refractive index: 1.79 | refractive index: 1.79 |

| Corrosion | Type | 2-mercaptobenzothiazole | 2-mercaptobenzothiazole |
|---|---|---|---|
| inhibitor | Amount added (parts by mass: solid | 5/optical adjustment layer | 5/optical adjustment layer |
| | content)/layer added | | |
| Fluorine-containing (meth)acrylate | | 6.93/low refractive index layer | 6.93/low refractive index layer |
| Amount added (parts by mass: resin content)/ | | | |
| layer added | | | |
| Silicone-modified acrylate | | 4.66/low refractive index layer | 1.33/low refractive index layer |
| Amount added (parts by mass: resin content)/ | | | |
| layer added | | | |
| Infrared | Second metal suboxide layer | TiOₓ layer: 2 nm | TiOₓ layer: 2 nm |
| reflective | Metal layer | Ag layer: 12 nm | Ag layer: 12 nm |
| layer | First metal (suboxide) oxide layer | TiOₓ layer: 2 nm | TiO₂ layer: 2 nm |
| | Total thickness (nm) | 16 | 16 |
| | Ratio of thickness of second metal | 12.5 | 12.5 |
| | suboxide layer (%) | | |

| | | |
|---|---|---|
| Thickness of protective layer (nm) | 300 | 300 |

| | | |
|---|---|---|
| Visible light transmittance (%) | 72.2 | 75.5 |
| Visible light reflectance (%) | 20.9 | 06.0 |
| Solar absorptance (%) | 16.8 | 16.2 |
| Shading coefficient | 0.59 | 0.62 |
| Thermal transmittance (W/(m² · K)) | 3.7 | 3.7 |
| Fingerprint wiping properties | excellent | excellent |
| Salt water resistance (T_{A} − T_{B}) | 1.0 | 2.2 |
| Scratch resistance | excellent | excellent |
| Appearance | excellent | excellent |

TABLE 6

| | | | Example 21 | Example 22 |
|---|---|---|---|---|
| Layer | Low refractive index layer | | low refractive index coating material A | low refractive index coating material A |
| configuration | | | thickness: 100 nm | thickness: 100 nm |
| | | | refractive index: 1.37 | refractive index: 1.37 |
| | High refractive index layer | | high refractive index coating material A | high refractive index coating material A |
| | | | thickness: 90 nm | thickness: 90 nm |
| | | | refractive index: 1.80 | refractive index: 1.80 |
| | Medium refractive index layer | | medium refractive index coating | medium refractive index coating |
| | | | material A | material A |
| | | | thickness: 60 nm | thickness: 60 nm |
| | | | refractive index: 1.50 | refractive index: 1.50 |
| | Optical adjustment layer | | optical adjustment coating material A | optical adjustment coating material A |
| | | | thickness: 50 nm | thickness: 50 nm |
| | | | refractive index: 1.79 | refractive index: 1.79 |
| | Corrosion | Type | 2-mercaptobenzothiazole | 2-mercaptobenzothiazole |
| | inhibitor | Amount added (parts by mass: solid | 5/optical adjustment layer | 5/optical adjustment layer |
| | | content)/layer added | | |
| | Fluorine-containing (meth)acrylate | | 6.93/low refractive index layer | 6.93/low refractive index layer |
| | Amount added (parts by mass: resin content)/ | | | |
| | layer added | | | |
| | Silicone-modified acrylate | | 1.83/low refractive index layer | 1.33/low refractive index layer |
| | Amount added (parts by mass: resin content)/ | | | |
| | layer added | | | |
| | Infrared | Second metal (suboxide) oxide layer | TiO₂ layer: 2 nm | TiO₂ layer: 2 nm |
| | reflective | Metal layer | Ag layer: 12 nm | Ag layer: 12 nm |
| | layer | First metal (suboxide) oxide layer | TiO₂ layer: 2 nm | TiO₂ layer: 2 nm |
| | | Total thickness (nm) | 16 | 16 |
| | | Ratio of thickness of second metal | 12.5 | 12.8 |
| | | suboxide layer (%) | | |

| | | |
|---|---|---|
| Thickness of protective layer (nm) | 300 | 300 |

| Visible light transmittance (%) | | | 75.6 | 77.6 |
|---|---|---|---|---|
| Visible light reflectance (%) | | | 19.7 | 18.4 |
| Solar absorptance (%) | | | 17.0 | 17.5 |
| Shading coefficient | | | 0.61 | 0.63 |
| Thermal transmittance (W/(m² · K)) | | | 3.7 | 3.7 |
| Fingerprint wiping properties | | | excellent | excellent |
| Salt water resistance (T_{A} − T_{B}) | | | 2.6 | 3.3 |
| Scratch resistance | | | excellent | excellent |
| Appearance | | | excellent | excellent |
| | | | Example 23 | Example 24 |
| | Layer | Low refractive index layer | low refractive index coating material D | low refractive index coating material D |
| | configuration | | thickness: 100 nm | thickness: 100 nm |
| | | | refractive index: 1.88 | refractive index: 1.38 |
| | | High refractive index layer | high refractive index coating material A | high refractive index coating material A |
| | | | thickness: 90 nm | thickness: 90 nm |
| | | | refractive index: 1.80 | refractive index: 1.80 |
| | | Medium refractive index layer | medium refractive index coating | medium refractive index coating |
| | | | material A | material A |
| | | | thickness: 60 nm | thickness: 60 nm |
| | | | refractive index: 1.50 | refractive index: 1.50 |
| | | Optical adjustment layer | optical adjustment coating material A | optical adjustment coating material B |
| | | | thickness: 50 nm | thickness: 50 nm |
| | | | refractive index: 1.79 | refractive index: 1.79 |

| Corrosion | Type | 2-mercaptobenzothiazole | 1-thioglycol |
|---|---|---|---|
| inhibitor | Amount added (parts by mass: solid | 5/optical adjustment layer | 5/optical adjustment layer |
| | content)/layer added | | |
| Fluorine-containing (meth)acrylate | | — | — |
| Amount added (parts by mass: resin content)/ | | | |
| layer added | | | |
| Silicone-modified acrylate | | — | — |
| Amount added (parts by mass: resin content)/ | | | |
| layer added | | | |
| Infrared | Second metal (suboxide) oxide layer | TiOₓ layer: 2 nm | TiOₓ layer: 2 nm |
| reflective | Metal layer | Ag layer: 12 nm | Ag layer: 12 nm |
| layer | First metal (suboxide) oxide layer | TiOₓ layer: 2 nm | TiOₓ layer: 2 nm |
| | Total thickness (nm) | 16 | 16 |
| | Ratio of thickness of second metal | 12.5 | 12.5 |
| | suboxide layer (%) | | |

| | | |
|---|---|---|
| Thickness of protective layer (nm) | 300 | 300 |

| | | |
|---|---|---|
| Visible light transmittance (%) | 71.9 | 71.8 |
| Visible light reflectance (%) | 20.9 | 20.9 |
| Solar absorptance (%) | 16.7 | 16.6 |
| Shading coefficient | 0.59 | 0.59 |
| Thermal transmittance (W/(m² · K)) | 3.7 | 3.7 |
| Fingerprint wiping properties | bad | bad |
| Salt water resistance (T_{A} − T_{B}) | 4.0 | 3.9 |
| Scratch resistance | good | good |
| Appearance | excellent | excellent |

TABLE 7

| | | | Example 25 | Example 26 |
|---|---|---|---|---|
| Layer | Low refractive index layer | | low refractive index coating material D | low refractive index coating material D |
| configuration | | | thickness: 100 nm | thickness: 95 nm |
| | | | refractive index: 1.35 | refractive index: 1.38 |
| | High refractive index layer | | high refractive index coating material A | high refractive index coating material B |
| | | | thickness: 290 nm | thickness: 145 nm |
| | | | refractive index: 1.80 | refractive index: 1.79 |
| | Medium refractive index layer | | medium refractive index coating | — |
| | | | material C | |
| | | | thickness: 150 nm | |
| | | | refractive index: 1.50 | |
| | Optical adjustment layer | | — | — |
| | Corrosion | Type | 2-mercaptobenzothiazole | 2-mercaptobenzothiazole |
| | inhibitor | Amount added (parts by mass: solid | 5/medium refractive index layer | 5/medium refractive index layer |
| | | content)/layer added | | |
| | Fluorine-containing (meth)acrylate | | — | — |
| | Amount added (parts by mass: resin content)/ | | | |
| | layer added | | | |
| | Silicone-modified acrylate | | — | — |
| | Amount added (parts by mass: resin content)/ | | | |
| | layer added | | | |
| | Infrared | Second metal suboxide layer | TiOₓ layer: 2 nm | TiOₓ layer: 2 nm |
| | reflective | Metal layer | Ag layer: 12 nm | Ag layer: 12 nm |
| | layer | First metal suboxide layer | TiOₓ layer: 2 nm | TiOₓ layer: 2 nm |
| | | Total thickness (nm) | 16 | 16 |
| | | Ratio of thickness of second metal | 12.5 | 12.5 |
| | | suboxide layer (%) | | |

| | | |
|---|---|---|
| Thickness of protective layer (nm) | 540 | 240 |

| | | |
|---|---|---|
| Visible light transmittance (%) | 72.2 | 65.5 |
| Visible light reflectance (%) | 22.0 | 29.8 |
| Solar absorptance (%) | 15.9 | 15.0 |
| Shading coefficient | 0.59 | 0.58 |
| Thermal transmittance (W/(m² · K)) | 3.7 | 3.7 |
| Fingerprint wiping properties | bad | bad |
| Salt water resistance (T_{A} − T_{B}) | 3.7 | 6.1 |
| Scratch resistance | excellent | good |
| Appearance | excellent | excellent |

| | | Example 27 | Example 28 |
|---|---|---|---|
| Layer | Low refractive index layer | — | low refractive index coating material E |
| configuration | | | thickness: 100 nm |
| | | | refractive index: 1.38 |
| | High refractive index layer | — | high refractive index coating material A |
| | | | thickness: 90 nm |
| | | | refractive index: 1.80 |
| | Medium refractive index layer | medium refractive index coating | medium refractive index coating |
| | | material E | material A |
| | | thickness: 980 nm | thickness: 60 nm |
| | | refractive index: 1.50 | refractive index: 1.50 |
| | Optical adjustment layer | — | optical adjustment coating material A |
| | | | thickness: 50 nm |
| | | | refractive index: 1.79 |

| Corrosion | Type | 2-mercaptobenzothiazole | 2-mercaptobenzothiazole |
|---|---|---|---|
| inhibitor | Amount added (parts by mass: solid | 5/optical adjustment layer | 5/optical adjustment layer |
| | content)/layer added | | |
| Fluorine-containing (meth)acrylate | | — | — |
| Amount added (parts by mass: resin content)/ | | | |
| layer added | | | |
| Silicone-modified acrylate | | — | — |
| Amount added (parts by mass: resin content)/ | | | |
| layer added | | | |
| Infrared | Second metal suboxide layer | TiOₓ layer: 2 nm | TiOₓ layer: 2 nm |
| reflective | Metal layer | Ag layer: 12 nm | Ag layer: 12 nm |
| layer | First metal suboxide layer | TiOₓ layer: 2 nm | TiOₓ layer: 2 nm |
| | Total thickness (nm) | 16 | 16 |
| | Ratio of thickness of second metal | 12.5 | 12.5 |
| | suboxide layer (%) | | |

| | | |
|---|---|---|
| Thickness of protective layer (nm) | 980 | 300 |

| | | |
|---|---|---|
| Visible light transmittance (%) | 64.0 | 72.0 |
| Visible light reflectance (%) | 30.0 | 20.8 |
| Solar absorptance (%) | 15.6 | 16.8 |
| Shading coefficient | 0.57 | 0.59 |
| Thermal transmittance (W/(m² · K)) | 4.2 | 3.7 |
| Fingerprint wiping properties | bad | good |
| Salt water resistance (T_{A} − T_{B}) | 2.0 | 3.5 |
| Scratch resistance | excellent | excellent |
| Appearance | good | excellent |

TABLE 8

| | | | Comparative Example 1 | Comparative Example 2 | Comparative Example 3 |
|---|---|---|---|---|---|
| Layer | Low refractive index layer | | low retractive index | low retractive index | low retractive index |
| configuration | | | coating material D | coating material D | coating material A |
| | | | thickness: 100 nm | thickness: 65 nm | thickness: 100 nm |
| | | | refractive index: 1.38 | refractive index: 1.38 | refractive index: 1.87 |
| | High refractive index layer | | high refractive index | — | high refractive index |
| | | | coating material A | | coating material A |
| | | | thickness: 90 nm | | thickness: 90 nm |
| | | | refractive index: 1.80 | | refractive index: 1.80 |
| | Medium retractive index layer | | medium refractive index | — | medium refractive index |
| | | | coating material A | | coating material A |
| | | | thickness: 60 nm | | thickness: 60 nm |
| | | | refractive index: 1.80 | | refractive index: 1.50 |
| | Optical adjustment layer | | optical adjustment | — | optical adjustment |
| | | | coating material H | | coating material A |
| | | | thickness: 50 nm | | thickness: 50 nm |
| | | | refractive index: 1.80 | | refractive index: 1.79 |
| | Corrosion | Type | — | — | 2-mercaptobezothiazole |
| | inhibitor | Amount added (parts by mass:solid | — | — | 5/optical adjustment layer |
| | | content)/layer added | | | |
| | Fluorine-containing (meth)acrylate | | — | — | 6.93/low refractive index |
| | Amount added (parts by mass:resin content)/ | | | | layer |
| | layer added | | | | |
| | Silicone-modified acrylate | | — | — | 1.88/low refractive index |
| | Amount added (parts by mass:resin content)/ | | | | layer |
| | layer added | | | | |
| | Infrared | Second metal (suboxide) oxide layer | TiOₓ layer: 2 nm | ZTO layer: 10 nm | TiO₂ layer: 7 nm |
| | reflective | Metal layer | Ag layer: 12 nm | Ag layer: 12 nm | Ag layer: 12 nm |
| | layer | First metal (suboxide) oxide layer | TiOₓ layer: 2 nm | ZTO layer: 10 nm | TiOₓ layer: 2 nm |
| | | Total thickness (nm) | 16 | 32 | 21 |
| | | Ratio of thickness of second metal | 12.5 | 31.3 | 33.8 |
| | | (suboxide) oxide layer (%) | | | |

| | | | |
|---|---|---|---|
| Thickness of protective layer (nm) | 300 | 65 | 300 |

| | | | |
|---|---|---|---|
| Visible light transmittance (%) | 71.5 | 73.0 | 80.2 |
| Visible light reflectance (%) | 20.9 | 19.2 | 12.6 |
| Solar absorptance (%) | 16.9 | 20.9 | 23.7 |
| Shading coefficient | 0.58 | 0.61 | 0.69 |
| Thermal transmittance (W/(m² · K)) | 3.7 | 3.7 | 3.7 |
| Fingerprint wiping properties | bad | bad | excellent |
| Salt water resistance (T_{A} − T_{B}) | 20.5 | 7.3 | 1.4 |
| Scratch resistance | excellent | bad | excellent |
| Appearance | excellent | excellent | excellent |

As shown in Tables 1 to 7, the infrared reflective films (transparent heat-shielding eat-insulating members) of all the examples other than Examples 11, 14, and 27 have a high visible light transmittance and do not impair the transparency and the visibility when they are applied to window glass. Moreover, the infrared reflective films have a low shading coefficient and a low thermal transmittance, so that both the heat shielding performance in summer and the heat insulation performance in winter can be improved. Since the infrared reflective films have a low solar absorptance, thermal cracking of glass is unlikely to occur after they are applied to window glass. Further, the results of the salt water resistance test that assumed a harsh external environment are good. Therefore, even if condensed water, human sebum, sweat, etc. adhere to the film surface, the metal layer of the infrared reflective layer will not be corroded and degraded in a short period of time. In the infrared reflective films of Examples 1 to 22, the layer of the protective layer that is located on the outermost side includes a fluorine-containing (meth)acrylate and a silicone-modified acrylate. Thus, the infrared reflective films of Examples 1 to 22 have better fingerprint wiping properties and water repellency, as compared to the infrared reflective films of Examples 23 to 27, in which the layer of the protective layer that is located on the outermost side does not include a fluorine-containing (meth)acrylate and a silicone-modified acrylate. Consequently, fingerprint traces are less likely to remain in routine cleaning of the film surface after the film has been applied, and the influence of external environmental factors can be further reduced. Thus, it is also possible to further reduce the influence on the corrosion and degradation of the metal layer in actual use.

In the infrared reflective films of Examples 11 and 27, the protective layer is composed of a single layer and has a large thickness of 980 nm. Therefore, the visible light transmittance is slightly lower, and the appearance is slightly inferior compared to the other examples. In the infrared reflective film of Examples 14, the metal layer of the infrared reflective layer has a large thickness of 19 nm. Therefore, the visible light transmittance is slightly lower compared to the other examples.

On the other hand, as shown in Table 8, in Comparative Example 1, the optical adjustment layer that is in contact with the second metal suboxide layer of the infrared reflective layer does not include a corrosion inhibitor for metal, and the low refractive index layer that is located on the outermost side of the protective layer does not include a fluorine-containing (meth)acrylate and a silicone-modified acrylate, Therefore, the results of the salt water resistance test are worse, and the corrosion and degradation of the metal layer of the infrared reflecting layer may be progressed.

In Comparative Example 2, the low refractive index layer that is in contact with the second metal oxide layer of the infrared reflective layer does not include a corrosion inhibitor for metal, but the metal oxide layer is made of ZTO with a thickness of 10 nm. Therefore, the results of the salt water resistance test are not bad. However, the total thickness of the infrared reflective layer is 32 nm, which is larger than 25 nm, and the thickness of the second metal oxide (ZTO) layer is 10 nm, corresponding to 31.3% of the total thickness of the infrared reflective layer, which is larger than 25%. Consequently, the solar absorptance is increased to 20.9%, so that the risk of thermal cracking of glass is increased when the film is applied to window glass.

In Comparative Example 3, the total thickness of the infrared reflective layer is 21 nm, the optical adjustment layer that is in contact with the second metal oxide (TiO₂) layer of the infrared reflective layer includes a corrosion inhibitor for metal, and the low refractive index layer that is located on the outermost side of the protective layer includes a fluorine-containing (meth)acrylate and a silicone-modified acrylate. Therefore, the visible light transmittance is high, and the results of the salt water resistance test are good. However, the thickness of the second metal oxide (TiO₂) layer is 7 nm, corresponding to 33.3% of the total thickness of the infrared reflective layer, which is larger than 25%. Consequently, the visible light reflectance is low and the solar absorptance is increased to 23.7%, so that the risk of thermal cracking of glass is increased when the film is applied to window glass.

The present invention may be embodied in other forms without departing from the spirit or essential characteristics thereof. The embodiments disclosed in this application are to be considered in all respects as illustrative and not limiting. The scope of the present invention is indicated by the appended claims rather than by the foregoing description, and all changes which come within the meaning and range of equivalency of the claims are intended to be embraced therein.

### INDUSTRIAL APPLICABILITY

The present invention can provide a transparent heat-shielding/heat-insulating member that can maintain high heat shielding performance and high heat insulation performance, have excellent resistance to corrosion and degradation in the salt water resistance test that assumed a harsh external environment, have a low solar absorptance, and reduce the risk of thermal cracking of glass when it is applied to, e.g., window glass.

### DESCRIPTION OF REFERENCE NUMERALS

10 Transparent heat-shielding/heat-insulating member
11 Transparent base substrate
12 First metal suboxide layer or metal oxide layer
13 Metal layer
14 Second metal suboxide layer or metal oxide layer
15 Optical adjustment layer
16 Medium refractive index layer
17 High refractive index layer
18 Low refractive index layer
19 Adhesive layer
21 Infrared reflective layer
22 Protective layer
23 Functional layer

1. A transparent heat-shielding/heat-insulating member comprising:
a transparent base material; and
a functional layer formed on the transparent base material,
wherein the functional layer includes an infrared reflective layer and a protective layer in this order from the transparent base material side,
the infrared reflective layer includes a first metal suboxide layer or metal oxide layer, a metal layer, and a second metal suboxide layer or metal oxide layer in this order from the transparent base material side,
a total thickness of the infrared reflective layer is 25 nm or less,
a thickness of the second metal suboxide layer or metal oxide layer is 25% or less of the total thickness of the infrared reflective layer,
the protective layer is composed of a single layer or multiple layers, and
at least the layer of the protective layer that is in contact with the second metal suboxide layer or metal oxide layer includes a corrosion inhibitor for metal.

2. The transparent heat-shielding/heat-insulating member according to claim 1, wherein the layer of the protective layer that is located on an outermost side includes a resin containing a fluorine atom and a siloxane bond.

3. The transparent heat-shielding/heat-insulating member according to claim 1, wherein the corrosion inhibitor for metal contains at least one compound selected from a compound having a nitrogen-containing group and a compound having a sulfur-containing group.

4. The transparent heat-shielding/heat-insulating member according to claim 1, wherein a content of the corrosion inhibitor for metal is 1% by mass or more and 20% by mass or less of a total mass of a layer including the corrosion inhibitor for metal.

5. The transparent heat-shielding/heat-insulating member according to claim 2, wherein the resin containing a fluorine atom and a siloxane bond is a copolymer resin that contains a fluorine-containing (meth)acrylate, a silicone-modified acrylate, and an ionizing radiation curable resin as pre-polymerization resin components, and
the ionizing radiation curable resin is copolymerizable with the fluorine-containing (meth)acrylate and the silicone-modified acrylate.

6. The transparent heat-shielding/heat-insulating member according to claim 5, wherein a content of the fluorine-containing (meth)acrylate is 4% by mass or more and 20% by mass or less of a total mass of the pre-polymerization resin components, and
a content of the silicone-modified acrylate is 1% by mass or more and 5% by mass or less of the total mass of the pre-polymerization resin components.

7. The transparent heat-shielding/heat-insulating member according to claim 1, wherein a total thickness of the infrared reflective layer is 7 nm or more.

8. The transparent heat-shielding/heat-insulating member according to claim 1, wherein the protective layer includes a high refractive index layer and a low refractive index layer in this order from the infrared reflective layer side.

9. The transparent heat-shielding/heat-insulating member according to claim 1, wherein the protective layer includes a medium refractive index layer, a high refractive index layer, and a low refractive index layer in this order from the infrared reflective layer side.

10. The transparent heat-shielding/heat-insulating member according to claim 1, wherein the protective layer includes an optical adjustment layer, a medium refractive index layer, a high refractive index layer, and a low refractive index layer in this order from the infrared reflective layer side.

11. The transparent heat-shielding/heat-insulating member according to claim 1, wherein a total thickness of the protective layer is 200 to 980 nm.

12. The transparent heat-shielding/heat-insulating member according to claim 1, wherein a metal suboxide or a metal oxide included in the second metal suboxide layer or metal oxide layer of the infrared reflective layer contains a titanium component.

13. The transparent heat-shielding/heat-insulating member according to claim 1, wherein the metal layer of the infrared reflective layer includes silver, and
a thickness of the metal layer is 5 to 20 nm.

14. The transparent heat-shielding/heat-insulating member according to claim 1, having a visible light transmittance of 60% or more,
a shielding coefficient of 0.69 or less,
an overall heat transfer coefficient of 4.0 W/(m²·K) or less, and
a solar absorptance of 20% or less.

15. The transparent heat-shielding/heat-insulating member according to claim 1, wherein a salt water resistance test is performed by immersing the transparent heat-shielding/heat-insulating member in a sodium chloride aqueous solution with a concentration of 5% by mass at 50° C. for 10 days, and a value of T_{A}-T_{B} is less than 10 points, where T_{B}% represents a transmittance of the transparent heat-shielding/heat-insulating member for light with a wavelength of 1100 nm of a transmission spectrum in a wavelength range of 300 to 1500 nm measured before the salt water resistance test, and T_{A}% represents a transmittance of the transparent heat-shielding/heat-insulating member for light with a wavelength of 1100 nm of the transmission spectrum in the wavelength range of 300 to 1500 nm measured after the salt water resistance test.

16. A method for producing the transparent heat-shielding/heat-insulating member according to claim 1,
the method comprising:
forming an infrared reflective layer on a transparent base material by a dry coating method; and
forming a protective layer on the infrared reflective layer by a wet coating method.
